(19) United States
(12) Patent Application Publication
(10) Pub. No.: US 2013/0057527 A1
(43) Pub. Date: Mar. 7, 2013

(54) DISPLAY DEVICE

(71) Applicants: Kohei Tanaka, Osaka-shi (JP); Yasuhiro Sugita, Osaka-shi (JP); Naru Usukura, Osaka-shi (JP); Kazuhiro Maeda, Osaka-shi (JP); Yousuke Nakagawa, Osaka-shi (JP)

(72) Inventors: Kohei Tanaka, Osaka-shi (JP); Yasuhiro Sugita, Osaka-shi (JP); Naru Usukura, Osaka-shi (JP); Kazuhiro Maeda, Osaka-shi (JP); Yousuke Nakagawa, Osaka-shi (JP)

(21) Appl. No.: 13/697,864

(22) PCT Filed: May 19, 2011
(86) PCT No.: PCT/JP2011/061524

§ 371 Date: Nov. 14, 2012

(30) Foreign Application Priority Data
May 20, 2010 (JP) 2010-116445

(51) Int. Cl. G06F 3/038

(52) U.S. Cl. 345/207

(57) ABSTRACT

Provided is a display device that is capable of ensuring a wide dynamic range of an optical sensor even in the case where an offset due to ambient temperature changes is compensated with use of an output of a reference element. The display device has optical sensors in a pixel region of an active matrix substrate (100), wherein the optical sensors include a photodetecting sensor which outputs a sensor signal according to an amount of received light, and a reference sensor which has a configuration obtained by adding a light shielding film to the photodetecting sensor and outputs a sensor signal according to an offset component. The display device includes: an offset comparison circuit (61) that determines a degree of divergence between the sensor signal output from the reference sensor and a standard offset value; and a driving signal generation circuit (62) that adjusts a potential of a driving signal for the optical sensors according to the degree of divergence determined by the offset comparison circuit (61).

### TECHNICAL FIELD

The present invention relates to a display device provided with optical sensors having photodetecting elements such as photodiodes, and particularly relates to a display device provided with these optical sensors in its pixel region.

### BACKGROUND ART

Conventionally, an optical-sensor-equipped display device has been proposed that is provided with, for example, photodetecting elements such as photodiodes in pixels, so as to be capable of detecting a brightness of external light and capturing an image of an object approaching its display panel. Such an optical-sensor-equipped display device is supposed to be used as a display device for two-way communication, or a display device having a touch panel function.

In the case of a conventional optical-sensor-equipped display device, when known constituent elements such as signal lines and scanning lines, TFTs (thin film transistors), and pixel electrodes are formed in an active matrix substrate through semiconductor processing, photodiodes and the like are formed on the active matrix substrate through the same processing (see JP 2006-3857 A).

It should be noted that it is known that a sensor output largely depends on an ambient temperature in an optical-sensor-equipped display device. In other words, there is a problem that when the ambient temperature varies, the characteristics of photodetecting elements fluctuate with the variation, which results in that variation of a light intensity cannot be detected correctly.

Such temperature dependence of an optical sensor is ascribed to a dark current (also referred to as a leak current). As a configuration for compensating this dark current, the following configuration is known: on an active matrix substrate, a light-shielded photodetecting element for detecting only a dark current (element for reference) as a so-called dummy sensor is provided in addition to an optical sensor having a photodetecting element for detecting an intensity of incident light (element for light detection) (see JP2007-18458 A). In this conventional configuration, an output from the element for reference reflects the dark current component. Therefore, a sensor output with an offset due to ambient temperature changes being compensated can be obtained by, in a circuit at a later stage of the optical sensor, subtracting an output of the element for reference from an output of the element for light detection.

To the capacitor of the element for light detection, however, both of a current generated due to incident light and a dark current are charged/discharged. Therefore, with an increase in the dark current at a high temperature, a problem arises that this configuration of obtaining a sensor output by subtracting an output of the element for reference from an output of the element for light detection causes the dynamic range of the optical sensor to be narrowed by the output value of the element for reference.

### DISCLOSURE OF THE INVENTION

In light of the above-described problem, it is an object of the present invention to provide a display device that is capable of ensuring a wide dynamic range of an optical sensor even in the case where an offset due to ambient temperature changes is compensated with use of an output of an element for reference.

A display device disclosed herein is a display device that has optical sensors in a pixel region of an active matrix substrate, wherein the optical sensors include a photodetecting sensor which outputs a sensor signal according to an amount of received light, and a reference sensor which has a configuration obtained by adding a light shielding film to the photodetecting sensor and outputs a sensor signal according to an offset component, and the display device includes: an offset comparison circuit that determines a degree of divergence between the sensor signal output from the reference sensor and a standard offset value; and a driving signal generation circuit that adjusts a potential of a driving signal for the optical sensors according to the degree of divergence determined by the offset comparison circuit.

With the present invention, it is possible to provide a display device that is capable of ensuring a wide dynamic range of an optical sensor even in the case where an offset due to ambient temperature changes is compensated with use of an output of a reference element.

### BRIEF DESCRIPTION OF DRAWINGS

FIG. 1 is a block diagram showing a schematic configuration of a display device according to one embodiment of the present invention.

FIG. 2 is an equivalent circuit diagram showing a configuration of a pixel in a display device according to Embodiment 1 of the present invention.

FIG. 3A is an equivalent circuit diagram of a photodetecting sensor.

FIG. 3B is an equivalent circuit diagram of a reference sensor.

FIG. 4 is a timing chart showing a waveform of a reset signal supplied from a reset signal line RST to an optical sensor, and a waveform of a readout signal supplied from a readout signal line RWS thereto, in the display device according to Embodiment 1 of the present invention.

FIG. 5 is a waveform diagram showing a relationship between input signals (the reset signal and the readout signal) and V_{INT} in the optical sensor of Embodiment 1.

FIG. 6 is a block diagram showing a schematic configuration of a compensation circuit provided in the display device of Embodiment 1.

FIG. 7 is a waveform diagram showing an exemplary readout signal after adjustment by the compensation circuit.

FIG. 8 is a signal waveform diagram showing potential variation (broken line) of V_{INT} in the case where the potential of a high level V_{RWS.H} of the readout signal is V_{DD}, and potential variation (solid line) of V_{INT} in the case where the potential of the high level V_{RWS. H} of the readout signal is (V_{DD}+α).

FIG. 9 is a waveform diagram showing another example of the readout signal after adjustment by the compensation circuit.

FIG. 10 is a timing chart showing a sensor driving timing in a display device according to Embodiment 1.

FIG. 11 is a circuit diagram showing an internal configuration of a sensor pixel readout circuit.

FIG. 12 is a waveform diagram showing a relationship among the readout signal, the sensor output, and an output of the sensor pixel readout circuit.

FIG. 13 is a circuit diagram showing an exemplary configuration of a sensor column amplifier.

FIG. 14 is an equivalent circuit diagram of a photodetecting sensor according to Embodiment 2.

FIG. 15 is a C-V characteristic diagram of a variable capacitor C_{INT} provided in an optical sensor according to Embodiment 2.

FIG. 16 is a waveform diagram showing a relationship between input signals (a reset signal, a readout signal) and V_{INT} in the optical sensor according to Embodiment 2.

FIG. 17 is a waveform diagram showing variation of a potential V_{INT} of an accumulation node from the end of an integration period over a readout period.

FIG. 18A is a schematic cross-sectional view showing transfer of charges in the case where a potential of a gate electrode is lower than a threshold voltage in a variable capacitor.

FIG. 18B is a schematic cross-sectional view showing transfer of charges in the case where the potential of the gate electrode is higher than the threshold voltage in the variable capacitor.

FIG. 19 is a block diagram showing a schematic configuration of a compensation circuit according to Embodiment 2.

FIG. 20 is a signal waveform showing potential variation (broken line) of V_{INT} before correction by a compensation circuit 70, and potential variation (solid line) of V_{INT} in the case where the potential of the low level V_{RWS. L} of the readout signal is decreased by α.

FIG. 21 is a block diagram showing a schematic configuration of a compensation circuit according to Embodiment 3.

FIG. 22 is a waveform diagram showing an exemplary reset signal after adjustment by the compensation circuit of Embodiment 3.

FIG. 23 is a signal waveform diagram showing potential variation (broken line) of V_{INT} in the case where the potential of a high level V_{RST.H} of a reset signal is V_{SS}, and potential variation (solid line) of V_{INT} in the case where the potential of the high level V_{RST. H} of the reset signal is (V_{SS}++).

FIG. 24 is an equivalent circuit diagram showing a configuration of one pixel in a display device according to an exemplary modification of Embodiment 3.

FIG. 25 is a timing chart showing a waveform of a reset signal supplied from a reset signal line RST to an optical sensor, and a waveform of a readout signal supplied from a readout signal line RWS thereto, in the display device according to an exemplary modification of Embodiment 3.

FIG. 26 is a waveform diagram showing variation of V_{INT} in the display device according to the exemplary modification of Embodiment 3.

FIG. 27 is an equivalent diagram showing a configuration of one pixel in a display device according to Embodiment 4.

FIG. 28 is a block diagram showing a schematic configuration of a compensation circuit according to Embodiment 4.

FIG. 29 is a signal waveform showing potential variation (broken line) of V_{INT} before a reset level potential V_{REF} is adjusted, and potential variation (solid line) of V_{INT} after the reset level potential V_{REF} is adjusted with an increase of α.

FIG. 30 is an equivalent circuit diagram showing a configuration of one pixel in a display device according to Embodiment 5.

FIG. 31 is a signal waveform diagram showing potential variation (broken line) of V_{INT} before the reset level potential V_{REF} is adjusted, and potential variation (solid line) of V_{INT} after the reset level potential V_{REF} is adjusted with an increase of α.

### EMBODIMENTS FOR CARRYING OUT THE INVENTION

A display device according to one embodiment of the present invention is a display device having optical sensors in a pixel region of an active matrix substrate, wherein the optical sensors include a photodetecting sensor which outputs a sensor signal according to an amount of received light, and a reference sensor which has a configuration obtained by adding a light shielding film to the photodetecting sensor and outputs a sensor signal according to an offset component, and the display device includes: an offset comparison circuit that determines a degree of divergence between the sensor signal output from the reference sensor and a standard offset value; and a driving signal generation circuit that adjusts a potential of a driving signal for the optical sensors according to the degree of divergence determined by the offset comparison circuit (first configuration).

Examples of more specific aspects of the first configuration include second to ninth configurations shown below.

The second configuration is a configuration obtained by modifying the first configuration so that each of the optical sensors includes: a light receiving element; a capacitor that charges/discharges an output electric current from the light receiving element; a switching element that is connected between one end of the light receiving element and one end of the capacitor; a reset signal line that is connected to the other end of the light receiving element and supplies a reset signal; and a readout signal line that is connected to the other end of the capacitor and supplies a readout signal, wherein the driving signal generation circuit adjusts at least one of potentials of a high level and a low level of the readout signal.

The third configuration is a configuration obtained by modifying the first configuration so that each of the optical sensors includes: a light receiving element; a variable capacitor that charges/discharges an output electric current from the light receiving element; a switching element that is connected between one end of the light receiving element and one end of the capacitor; a reset signal line that is connected to the other end of the light receiving element and supplies a reset signal; and a readout signal line that is connected to the other end of the capacitor and supplies a readout signal, wherein the driving signal generation circuit adjusts a potential of a low level of the readout signal.

The fourth configuration is a configuration obtained by modifying the first configuration so that each of the optical sensors includes: a light receiving element; a capacitor that charges/discharges an output electric current from the light receiving element; a switching circuit that is connected between one end of the light receiving element and one end of the capacitor; a reset signal line that is connected to the other end of the light receiving element and supplies a reset signal; and a readout signal line that supplies a readout signal to the optical sensor, wherein the driving signal generation circuit adjusts a potential of a high level of the reset signal.

The fifth configuration is a configuration obtained by modifying the fourth configuration so that the switching circuit includes one transistor, and the readout signal line is connected to the other end of the capacitor.

The sixth configuration is a configuration obtained by modifying the fourth configuration so that the switching circuit includes a first transistor and a second transistor, a control electrode of the first transistor is connected between one end of the light receiving element and one end of the capacitor, one of two electrodes other than the control electrode in the first transistor is connected to a line that supplies a constant voltage, the other one of the two electrodes other than the control electrode in the first transistor is connected to one of two electrodes other than a control electrode in the second transistor, the other one of the two electrodes other than the control electrode in the second transistor is connected to an output line for outputting the sensor signal, the readout signal line is connected to the control electrode of the second transistor, and the other end of the capacitor is connected to a line that supplies a constant voltage.

The seventh configuration is a configuration obtained by modifying the first configuration so that the switching circuit includes a first transistor, a second transistor, and a third transistor, a control electrode of the first transistor is connected between one end of the light receiving element and one end of the capacitor, one of two electrodes other than the control electrode in the first transistor is connected to a line that supplies a constant voltage, the other one of the two electrodes other than the control electrode in the first transistor is connected to one of two electrodes other than a control electrode in the second transistor, the other one of the two electrodes other than the control electrode in the second transistor is connected to an output line for outputting the sensor signal, the other end of the capacitor is connected to a line that supplies a constant voltage, the readout signal line is connected to the control electrode of the second transistor, the reset signal line is connected to a control electrode of the third transistor, one of two electrodes other than the control electrode in the third transistor is connected to one end of the light receiving element, the other one of the two electrodes other than the control electrode in the third transistor is connected to a line that supplies a reference voltage, and the driving signal generation circuit adjusts a potential of the reference voltage for the third transistor.

The eighth configuration is a configuration obtained by modifying the first configuration so that the switching circuit includes a first transistor and a second transistor, a control electrode of the first transistor is connected between one end of the light receiving element and one end of the capacitor, one of two electrodes other than the control electrode in the first transistor is connected to a line that supplies a constant voltage, the other one of the two electrodes other than the control electrode in the first transistor is connected to an output line for outputting the sensor signal, the other end of the capacitor is connected to the readout signal line, the reset signal line is connected to a control electrode of the second transistor, one of two electrodes other than the control electrode in the second transistor is connected to one end of the light receiving element, the other one of the two electrodes other than the control electrode in the second transistor is connected to a line that supplies a reference voltage, and the driving signal generation circuit adjusts at least one of potentials of a high level and a low level of the readout signal.

The ninth configuration is a configuration obtained by modifying the first configuration so that the switching circuit includes a first transistor and a second transistor, a control electrode of the first transistor is connected between one end of the light receiving element and one end of the capacitor, one of two electrodes other than the control electrode in the first transistor is connected to a line that supplies a constant voltage, the other one of the two electrodes other than the control electrode in the first transistor is connected to an output line for outputting the sensor signal, the other end of the capacitor is connected to the readout signal line, the reset signal line is connected to a control electrode of the second transistor, one of two electrodes other than the control electrode in the second transistor is connected to one end of the light receiving element, the other one of the two electrodes other than the control electrode in the second transistor is connected to a line that supplies a reference voltage, and the driving signal generation circuit adjusts a potential of the reference voltage.

Further, a display device according to one embodiment of the present invention preferably has a configuration obtained by modifying any one of the first to ninth configurations so that the display device further includes: a counter substrate opposed to the active matrix substrate; and liquid crystal interposed between the active matrix substrate and the counter substrate.

### EMBODIMENT

Hereinafter, more specific embodiments of the present invention are explained with reference to the drawings. It should be noted that the following embodiments show exemplary configurations in the case where a display device according to the present invention is embodied as a liquid crystal display device, but the display device according to the present invention is not limited to a liquid crystal display device, and the present invention is applicable to an arbitrary display device in which an active matrix substrate is used. It should be noted that a display device according to the present invention, as having optical sensors, is assumed to be used as a touch-panel-equipped display device that detects an object approaching its screen and carries out an input operation, as a display device for two-way communication having a display function and an image pickup function, etc.

Further, the drawings referred to hereinafter show, in a simplified manner, only principal members needed for explanation of the present invention among constituent members of the embodiment of the present invention, for convenience of explanation. Therefore, a display device according to the present invention may include arbitrary members that are not shown in the drawings that the present specification refers to. Further, the dimensions of the members shown in the drawings do not faithfully reflect actual dimensions of constituent members, dimensional ratios of the members, etc.

### Embodiment 1

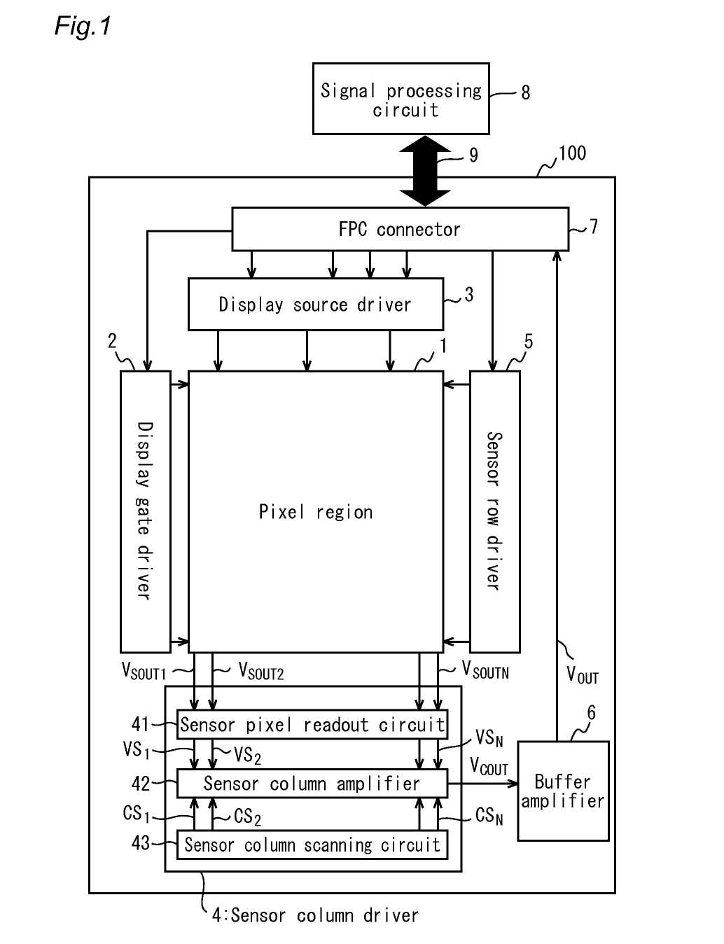

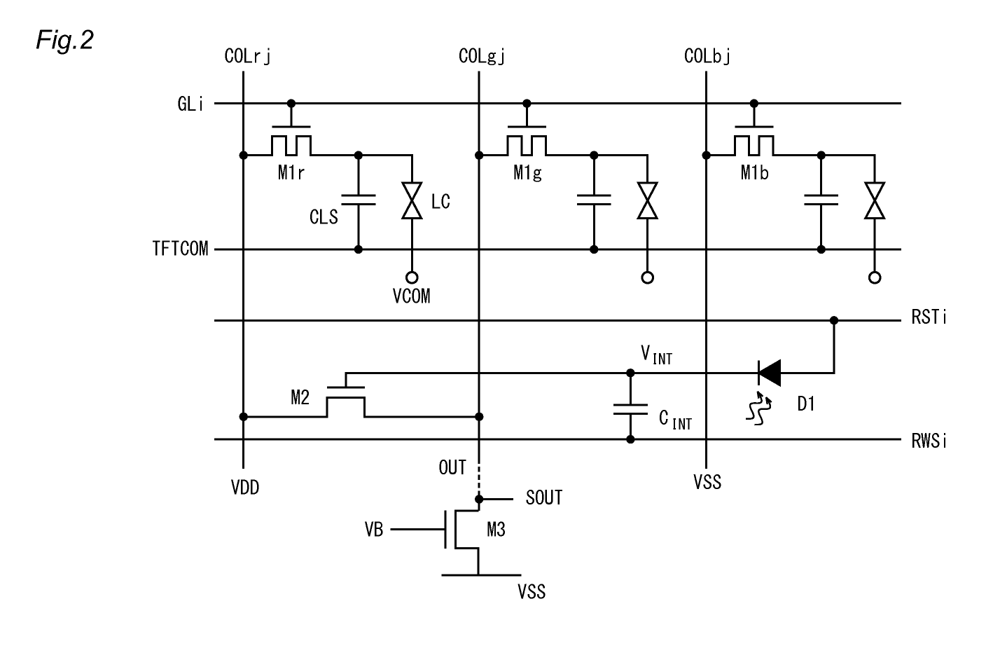

First, a configuration of an active matrix substrate provided in a liquid crystal display device according to Embodiment 1 of the present invention is explained, with reference to FIGS. 1 and 2.

FIG. 1 is a block diagram illustrating a schematic configuration of an active matrix substrate 100 provided in a liquid crystal display device according to one embodiment of the present invention. As shown in FIG. 1, the active matrix substrate 100 includes, on its glass substrate, at least a pixel region 1, a display gate driver 2, a display source driver 3, a sensor column driver 4, a sensor row driver 5, a buffer amplifier 6, and an FPC connector 7. Further, a signal processing circuit 8 for processing an image signal captured by a photodetecting element (to be described later) in the pixel region 1 is connected to the active matrix substrate 100 via the FPC connector 7 and an FPC 9.

It should be noted that the above-described constituent members on the active matrix substrate 100 may be formed monolithically on the glass substrate through semiconductor processing. Alternatively, the configuration may be as follows: the amplifiers and drivers among the above-described members are mounted on the glass substrate by, for example, COG (chip on glass) techniques. Further alternatively, at least a part of the aforementioned members shown on the active matrix substrate 100 in FIG. 1 could be mounted on the FPC 9. The active matrix substrate 100 is laminated with a counter substrate (not shown) having a counter electrode formed over an entire surface thereof. A liquid crystal material is sealed in the space between the active matrix substrate 100 and the counter substrate.

The pixel region 1 is a region where a plurality of pixels are formed for displaying images. In the present embodiment, an optical sensor for capturing images is provided in each pixel in the pixel region 1. FIG. 2 is an equivalent circuit diagram showing an arrangement of pixels and optical sensors in the pixel region 1 in the active matrix substrate 100. In the example shown in FIG. 2, one pixel is formed with three primary color dots of three colors, i.e., R (red), G (green), and B (blue) (the primary color dots are referred to as “sub-pixels” as well). In one pixel composed of these three color dots, there is provided one optical sensor composed of one photodiode (photodiode D1 in the example shown in FIG. 2), a capacitor C_{INT}, and a thin film transistor M2. The pixel region 1 includes the pixels arrayed in a matrix of M rows×N columns, and the optical sensors arrayed likewise in a matrix of M rows×N columns. It should be noted that the number of the color dots is M×3N, as described above.

As shown in FIG. 2, therefore, the pixel region 1 has gate lines GL and source lines COL arrayed in matrix as lines for pixels. The gate lines GL are connected with the display gate driver 2. The source lines COL are connected with the display source driver 3. It should be noted that M rows of the gate lines GL are provided in the pixel region 1. Hereinafter, when an individual gate line GL needs to be described distinctly, it is denoted by GLi (i=1 to M). On the other hand, three source lines COL are provided per one pixel so as to supply image data to three color dots in the pixel, as described above. When an individual source line COL needs to be described distinctly, it is denoted by COLrj, COLgj, or COLbj (j=1 to N).

At each of intersections of the gate lines GL and the source lines COL, a thin-film transistor (TFT) M1 is provided as a switching element for a pixel. It should be noted that in FIG. 2, the thin film transistors M1 provided for color dots of red, green, and blue are denoted by M1r, M1g, and M1b, respectively. A gate electrode of the thin-film transistor M1 is connected to the gate line GL, a source electrode thereof is connected to the source line COL, and a drain electrode thereof is connected to a pixel electrode, which is not shown. Thus, a liquid crystal capacitor LC is formed between the drain electrode of the thin film transistor M1 and the counter electrode (VCOM), as shown in FIG. 2. Further, an auxiliary capacitor CLS is formed between the drain electrode and a TFTCOM.

In FIG. 2, for a color dot driven by a thin-film transistor M1r connected to an intersection of one gate line GLi and one source line COLrj, a red color filter is provided so as to correspond to this color dot. This color dot is supplied with image data of red color from the display source driver 3 via the source line COLrj, thereby functioning as a red color dot. Further, for a color dot driven by a thin-film transistor M1g connected to an intersection of the gate line GLi and the source line COLgj, a green color filter is provided so as to correspond to this color dot. This color dot is supplied with image data of green color from the display source driver 3 via the source line COLgj, thereby functioning as a green color dot. Still further, for a color dot driven by a thin-film transistor M1b connected to an intersection of the gate line GLi and the source line COLbj, a blue color filter is provided so as to correspond to this color dot. This color dot is supplied with image data of blue color from the display source driver 3 via the source line COLbj, thereby functioning as a blue color dot.

It should be noted that in the example shown in FIG. 2, the optical sensors are provided so that one optical sensor corresponds to one pixel (three color dots) in the pixel region 1. The ratio between the pixels and the optical sensors provided, however, is not limited to this example, but is arbitrary. For example, one optical sensor may be provided per one color dot, or one optical sensor may be provided per a plurality of pixels.

The optical sensor includes a photodiode D1, a capacitor C_{INT}, and a thin-film transistor M2, as shown in FIG. 2. It should be noted that a PN-junction diode or a PIN junction diode having a lateral structure or a laminate structure, for example, can be used as the photodiode D1. The optical sensor provided with the photodiode D1 functions as a photodetecting sensor that outputs a sensor signal corresponding to an amount of received light.

Further, the display device according to the present embodiment includes a reference sensor that has a configuration obtained by adding a light shielding film to the photodetecting sensor and outputs a sensor signal corresponding to an offset component, the reference sensor being provided in each of some pixels in the pixel region.

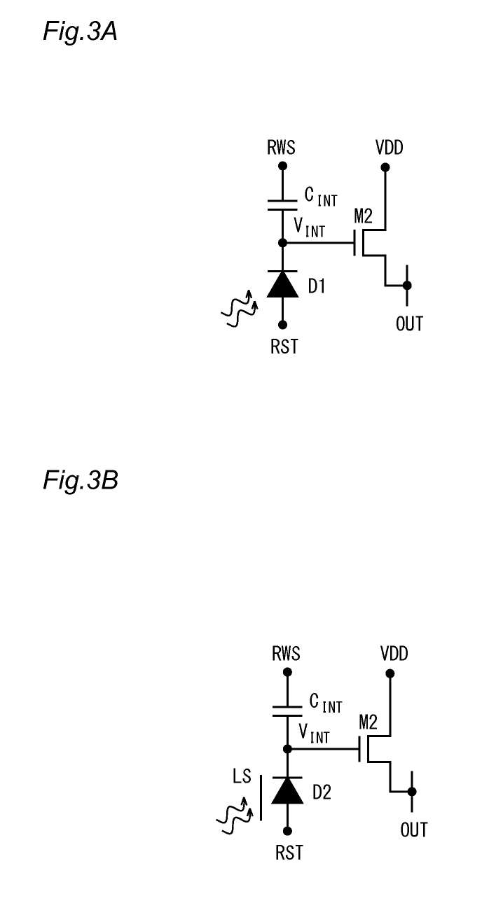

FIG. 3A is an equivalent circuit diagram of a photodetecting sensor provided with the photodiode D1. FIG. 3B is an equivalent circuit diagram of a reference sensor provided with a photodiode D2. As is clear from FIGS. 3A and 3B, the reference sensor has the same configuration as that of the photodetecting sensor except that the reference sensor has a light shielding film LS. It should be noted that the photodiode D1 of the photodetecting sensor and the photodiode D2 of the reference sensor are designed so as to have the same I-V characteristics. It is necessary that the light shielding film LS is provided so as to cover at least a photodetecting section in the photodiode D2. The light shielding film LS may be provided so as to cover an entirety of the circuit of the reference sensor or an entirety of a pixel including the reference sensor.

In the pixel region 1, the positions where the reference sensors are provided, and the number of the reference sensors, are arbitrary. For example, the reference sensors may be arranged in the pixels in peripheral areas of the pixel region 1. Alternatively, the reference sensors may be arranged in pixels at ends on one side, or at ends on both sides, in the row direction or the column direction in the pixel region 1. Further alternatively, the configuration may be such that the photodetecting sensors and the reference sensors are regularly arranged over an entirety of the pixel region 1.

In the example shown in FIG. 2, the source line COLr also functions as a line VDD for supplying a constant voltage V_{DD} to the optical sensor from the sensor column driver 4. Further, the source line COLg also functions as the line OUT for outputting a sensor output.

To an anode of the photodiode D1, a reset signal line RST for supplying a reset signal is connected. A cathode of the photodiode D1 is connected between a gate of the transistor M2 and one of electrodes of the capacitor C_{INT}.

A drain of the thin film transistor M2 is connected to the line VDD, and a source thereof is connected to the line OUT. Reset signal lines RST and readout signal lines RWS are connected to the sensor row driver 5. These reset signal lines RST and readout signal lines RWS are provided per each row. Therefore, hereinafter, when the lines should be distinguished, they are referred to as reset signal lines RSTi and readout signal lines RWSi (i=1 to M).

The sensor row driver 5 selects combinations of the reset signal line RSTi and the readout signal line RWSi shown in FIG. 2 sequentially at predetermined time intervals (t_{row}). In this way, the rows of the optical sensors from which signal charges are to be read out in the pixel region 1 are selected sequentially.

As shown in FIG. 2, a drain of a thin film transistor M3 as an insulated gate field effect transistor is connected to an end of the line OUT. To the drain of the thin film transistor M3, the output line SOUT is connected. Therefore, a potential V_{SOUT} of the drain of the thin film transistor M3 is output as an output signal from the optical sensor, to the sensor column driver 4. A source of the thin film transistor M3 is connected to the line VSS. A gate of the thin film transistor M3 is connected to a reference voltage source (not shown) via a reference voltage line VB.

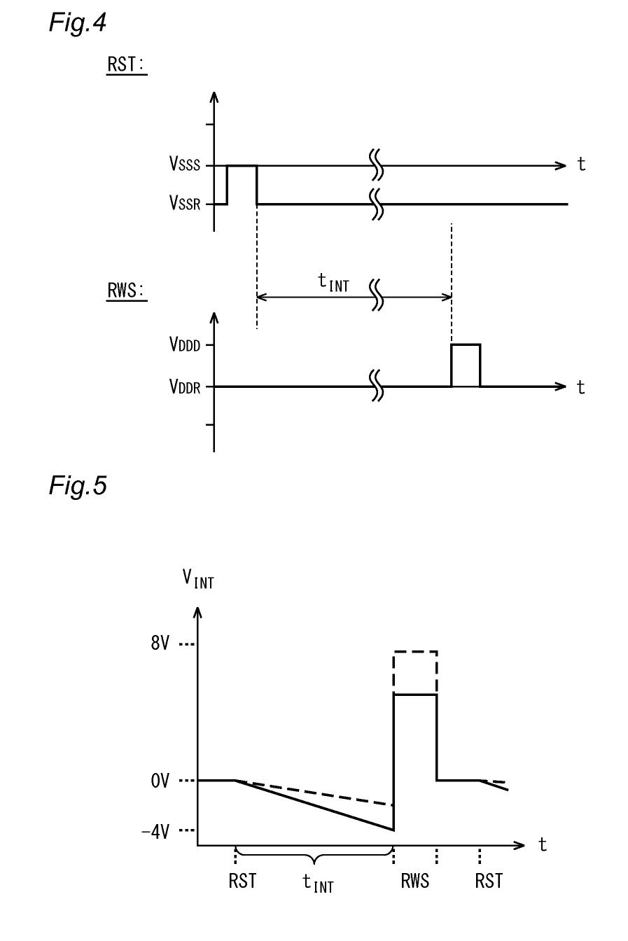

Here, operations of the optical sensor according to the present embodiment are explained with reference to FIGS. 4 and 5. It should be noted that the photodetecting sensor provided with the photodiode D1 and the reference sensor provided with the photodiode D2 are different only in that the photodiode D2 does not receive external light, and therefore, exemplary actions of the photodetecting sensor having the photodiode D1 are explained mainly in the following explanation.

FIG. 4 is a timing chart showing a waveform of a reset signal supplied from the reset signal line RST to the optical sensor, and a waveform of the readout signal supplied from the readout signal line RWS thereto. FIG. 5 is a waveform diagram showing a relationship between input signals (the reset signal and the readout signal) and V_{INT} in the optical sensor of Embodiment 1.

In the example shown in FIG. 4, a high level V_{RST.H} of the reset signal RST is a constant voltage V_{SSS} (e.g., 0 V), and a low level V_{RST.L} thereof is a constant voltage V_{SSR} (e.g., −4 V). A high level V_{RWS.H} of the readout signal RWS is a constant voltage V_{DDD} (e.g., 8 V), and a low level V_{RWS.L} thereof is a constant voltage V_{DDR} (e.g., 0 V). It should be noted that in the example of FIG. 4, the high level V_{RST.H} (V_{SSS}) of the reset signal and the low level V_{RWS.L} (V_{DDR}) of the readout signal are set to be equal potentials (0 V). It should be noted that these exemplary voltages are merely examples, and the potentials of the respective levels can be set appropriately.

First, when the reset signal supplied from the sensor row driver 5 to the reset signal line RST rises from the low level (−4 V) to the high level (0 V), the photodiode D1 is forward-biased. Here, the potential V_{INT} of the gate electrode of the thin film transistor M2 is lower than a threshold voltage of the thin film transistor M2, the thin film transistor M2 is non-conductive. The potential V_{INT} of the node INT upon reset is expressed by the following formula (1).

V_{INT}=V_{RST.H}−V_{F} (1)

In the formula (1), V_{RST.H} is 0 V as the high level of the reset signal, and V_{F} represents a forward voltage of the photodiode D1. Since the V_{INT} here is lower than a threshold voltage of the thin film transistor M2, the transistor M2 is non-conductive during the reset period.

Next, the reset signal returns to the low level V_{RST.L}, and thereby a photoelectric current integration period (t_{INT}) starts. During the integration period, in the photodetecting sensor provided with the photodiode D1, a sum of a photoelectric current I_{PHOTO} generated by incident light and a dark current I_{DARK} flows out of the capacitor C_{INT}, whereby the capacitor C_{INT} is discharged. Accordingly, the potential V_{INT} of the node INT in the photodetecting sensor provided with the photodiode D1 at the end of the integration period is expressed by the following formula (2). In the following formula (2), ΔV_{RST} represents an amplitude of a pulse of the reset signal (V_{RST. H}−V_{RST.L}), and C_{PD} represents a capacitance of the photodiode D1. C_{T} represents a total capacitance of the node INT. In other words, C_{T} is equal to a sum of the capacitance C_{INT} of the capacitor C_{INT}, the capacitance C_{PD} of the photodiode D1, and a capacitance C_{TFT} of the transistor M2.

V_{INT}=V_{RST.H}−V_{F}−ΔV_{RST}·C_{PD}/C_{T}−(I_{PHOTO}+I_{DARK})·t_{INT}/C_{T} (2)

On the other hand, in the reference sensor provided with the photodiode D2, the component of the photoelectric current I_{PHOTO} is zero in the formula (2), and discharge corresponding to only the dark current I_{DARK} occurs to the capacitor C_{INT}. It should be noted that the transistor M2 is non-conductive since V_{INT} is lower than the threshold voltage of the transistor M2 during the integration period as well.

After the integration period ends, as shown in FIG. 4, the readout signal RWS rises, and the readout period thereby starts. Here, the injection of charges into the capacitor C_{INT} occurs. As a result, the potential V_{INT} of the node INT is expressed by the following formula (3):

V_{INT}=V_{RST.H}−V_{F}−(I_{PHOTO}+I_{DARK})·t_{INT}/C_{T}+ΔV_{RWS}·C_{INT}/C_{T} (2)

ΔV_{RWS} is an amplitude of a pulse of the readout signal (V_{RST. H}−V_{RWS. L}). With this, the potential V_{INT} of the node INT becomes higher than the threshold voltage of the transistor M2. This causes the transistor M2 to become conductive. Thus, the transistor M2, together with the bias transistor M3 provided at an end of the line OUT in each column, functions as a source-follower amplifier. In other words, from the photodetecting sensor provided with the photodiode D1, a voltage obtained by amplifying an integral of the sum of the photoelectric current I_{PHOTO} owing to light incident on the photodiode D1 during the integration period and the dark current I_{DARK} is obtained as an output signal voltage Vout_D1 from the output line SOUT from the drain of the thin film transistor M3. Besides, from the reference sensor provided with the photodiode D2, a voltage obtained by amplifying an integral of the dark current I_{DARK} during the integration period is obtained as an output signal voltage Vout_D2 from the output line SOUT from the drain of the thin film transistor M3.

It should be noted that in FIG. 5, the waveform indicated by a solid line represents variation of the potential V_{INT} of the photodetecting sensor having the photodiode D1 in the case where external light is incident. The waveform indicated by a wavy line represents variation of the potential V_{INT} of the reference sensor having the photodiode D2. In the variation of the potential V_{INT} of the reference sensor indicated by the broken line, the decrease in the potential V_{INT} from the reset level (0 V in the example shown in FIG. 5) corresponds to an offset component corresponding to the dark current and the like.

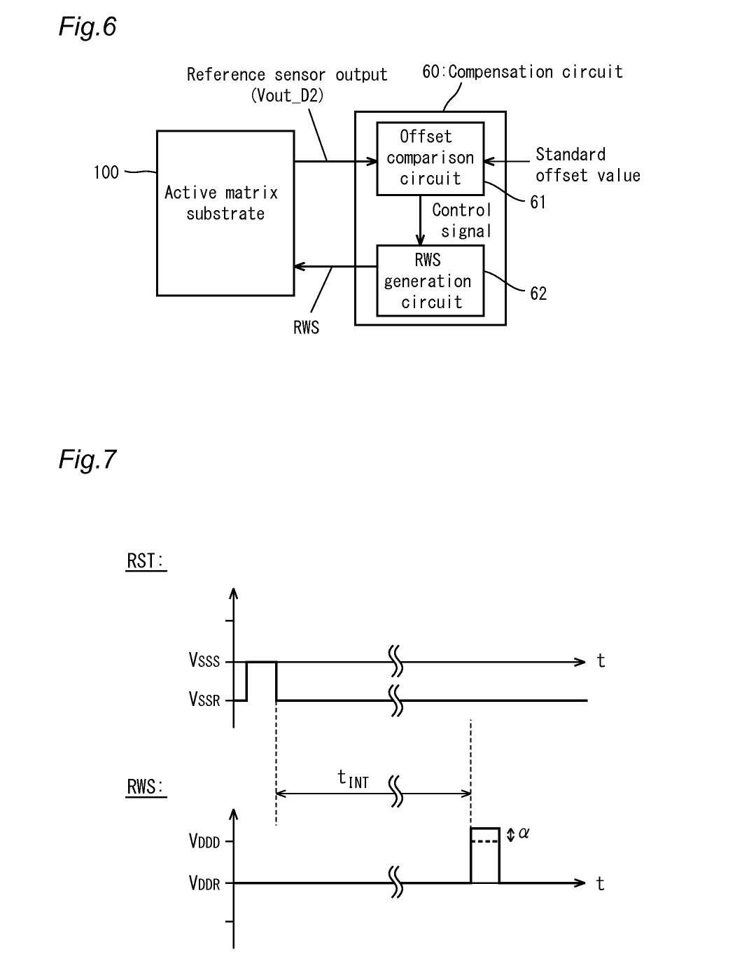

The display device according to the present embodiment includes a compensation circuit 60 shown in FIG. 6. The compensation circuit 60 is provided outside the active matrix substrate 100 (e.g., in the signal processing circuit 8) in the example of FIG. 6, but it may be provided in the sensor row driver 5 instead. The compensation circuit 60 includes an offset comparison circuit 61, and an RWS generation circuit 62 (driving signal generation circuit). The offset comparison circuit 61 compares an output signal voltage Vout_D2 from the reference optical sensor and a predetermined standard offset value, determines a degree of divergence therebetween, and outputs a control signal corresponding to the divergence degree thus determined, to the RWS generation circuit 62. The RWS generation circuit 62 controls an amplitude of a readout signal (RWS) based on the control signal from the offset comparison circuit 61.

A more detailed example is explained below. The offset comparison circuit 61 stores, as a standard offset value, a value obtained by A/D conversion of an output signal voltage Vout_D2 obtained from the reference optical sensor when ambient environments such as temperature and illuminance are set to predetermined conditions, in a memory preliminarily, for example, before factory shipment. It should be noted that the temperature and the illuminance when this standard offset value is obtained are not limited particularly. Regarding the illuminance, however, the sensor output characteristics with respect to the illuminance is linear preferably (including 0 lux, i.e., no light incidence).

The offset comparison circuit 61 receives an output signal voltage Vout_D2 (output from the reference sensor), and determines a degree of divergence between a value (gray scale data) obtained by A/D conversion of the received voltage and the standard offset value. The offset comparison circuit 61 stores, for example, a function or a lookup table that outputs an adjustment value for the amplitude of the readout signal, as a control signal in the case where, for example, a degree of divergence between the gray scale data and the standard offset value is input. The offset comparison circuit 61 outputs a control signal (adjustment value for the amplitude of the readout signal) corresponding to a degree of divergence between the gray scale data of the output signal Vout_D2 of the reference sensor and the standard offset value, using this function or table.

It should be noted that the adjustment of the amplitude of the readout signal by the compensation circuit 60 may be carried out per one frame, or at the actuation of the display device. Alternatively, it may be carried out at predetermined time intervals. The timing of performing the adjustment is not limited particularly.

FIG. 7 is a waveform diagram showing an exemplary readout signal after adjustment by the compensation circuit 60. As shown in FIG. 7, the RWS generation circuit 62 increases the potential of the high level V_{RWS.H} of the readout signal, which is V_{DDD} before correction (see FIG. 4), by α. Thus, the RWS generation circuit 62 increases the amplitude (V_{RWS.H}−V_{RWS.L}) of the readout signal by α. This offset potential α is a value determined by the offset comparison circuit 61 according to the degree of divergence between the output signal voltage Vout_D2 of the reference sensor and the standard offset value.

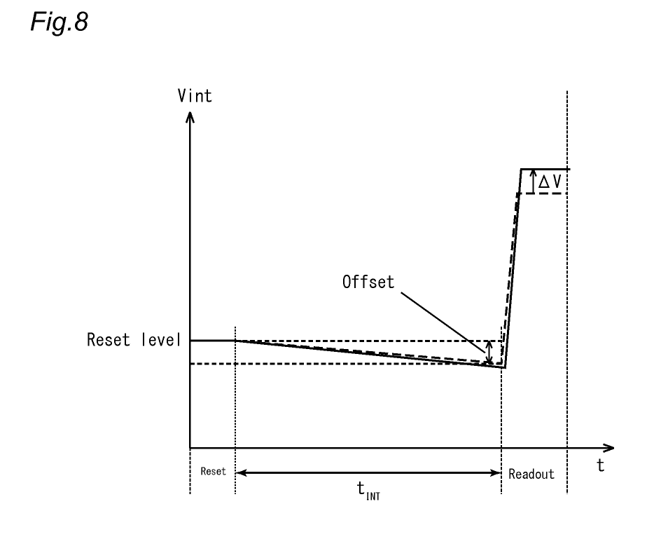

FIG. 8 is a signal waveform diagram showing potential variation (broken line) of V_{INT} in the case where the potential of the high level V_{RWS.H} of the readout signal is V_{DDD}, and potential variation (solid line) of V_{INT} in the case where the potential of the high level V_{RWS.H} of the readout signal is (V_{DDD}+α). As shown in FIG. 8, the potential of the high level V_{RWS.H} of the readout signal is set to (V_{DDD}+α), and thereby the potential of V_{INT} increases by a voltage ΔV corresponding to the offset α. It should be noted that the magnitude of the voltage ΔV is strictly (α·C_{INT}/C_{T}), according to the above-described formula (3).

As described above, by setting the potential of the high level V_{RWS.H} of the readout signal to (V_{DDD}+α) according to the degree of divergence between the gray scale data of the output signal voltage Vout_D2 and the standard offset value, a signal with an offset due to a dark current or the like being eliminated can be obtained as an output signal voltage Vout_D1.

Further, according to the present embodiment, subtraction of an output of the reference sensor from an output of the photodetecting sensor as in the conventional configuration is not needed. Therefore, a problem that the dynamic range of the sensor output is narrowed does not arise. This makes it possible to realize a display device that is capable of detecting an intensity of external light with high precision without being influenced by ambient temperature, and that is provided with an optical sensor having a wide dynamic range.

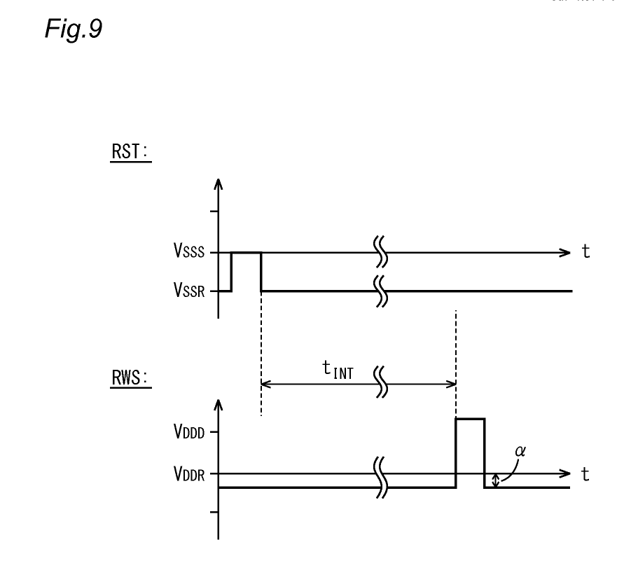

It should be noted that in the example shown in FIG. 7, the amplitude of the readout signal is increased by a by changing the potential of the high level V_{RWS.H} of the readout signal from V_{DDD} to (V_{DDD}+α). However, as shown in FIG. 9, by changing the potential of the low level V_{RWS.L} of the readout signal from V_{SSR} to (V_{SSR}−α), the amplitude of the readout signal can be increased by α, and therefore, the same effect can be achieved.

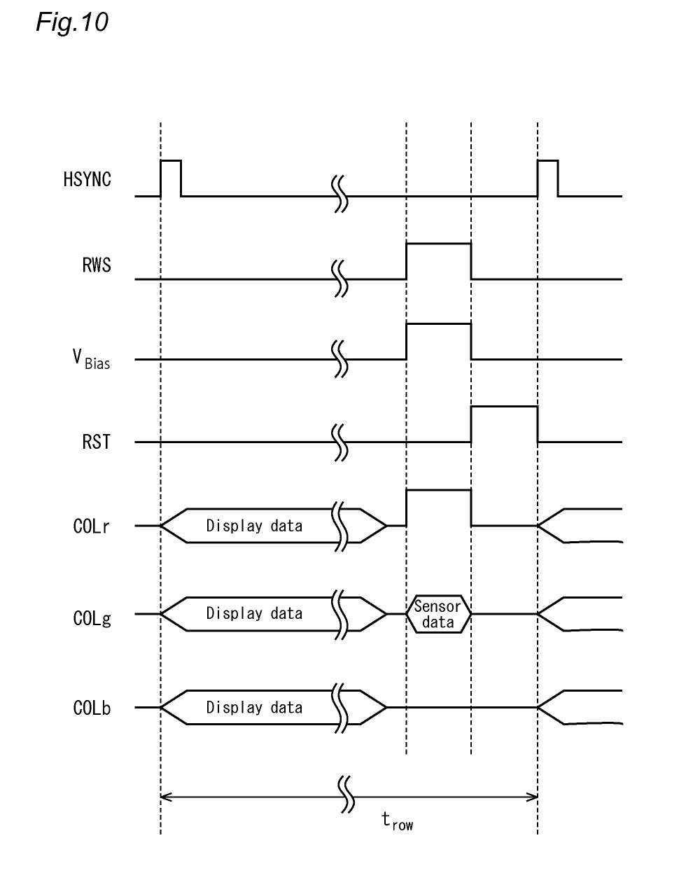

It should be noted that in the present embodiment, as described above, the source lines COLr and COLg double as the lines VDD and OUT for the optical sensor, respectively. Therefore, as shown in FIG. 10, it is necessary to distinguish the timings of inputting image data signals for display via the source lines COLr, COLg, and COLb, and the timings of reading out the sensor outputs. In the example shown in FIG. 10, after the input of image data signals for display ends during the horizontal scanning period, the readout of sensor outputs is carried out by using a horizontal blanking period or the like. In other words, after the input of image data signals for display ends, the constant voltage V_{DDD} is applied to the source line COLr. It should be noted that “HSYNC” in FIG. 10 represents a horizontal synchronization signal.

The sensor column driver 4 includes a sensor pixel readout circuit 41, a sensor column amplifier 42, and a sensor column scanning circuit 43, as shown in FIG. 1. To the sensor pixel readout circuit 41, an output line SOUT (see FIG. 2) for outputting a sensor output V_{SOUT} from the pixel region 1 is connected. In FIG. 1, a sensor output from an output line SOUTj (j=1 to N) is denoted by V_{SOUTj}. The sensor pixel readout circuit 41 outputs a peak hold voltage V_{Sj} of the sensor output V_{SOUTj} to the sensor column amplifier 42. The sensor column amplifier 42 incorporates N column amplifiers that correspond to N columns of optical sensors in the pixel region 1, respectively. The sensor column amplifier 42 amplifies the peak hold voltage V_{Sj} (j=1 to N) by each column amplifier, thereby outputting it as V_{COUT} to the buffer amplifier 6. The sensor column scanning circuit 43 outputs a column select signal C_{Sj} (j=1 to N) to the sensor column amplifier 42 in order to connect the column amplifiers of the sensor column amplifier 42 sequentially to the output of the buffer amplifier 6.

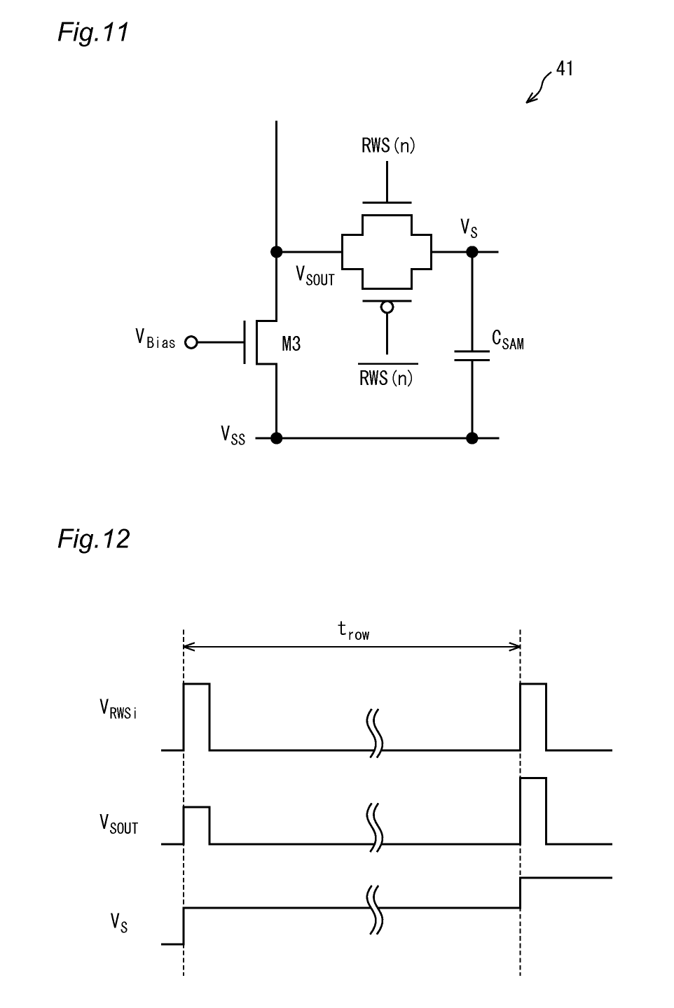

Here, an operation of the sensor column driver 4 and the buffer amplifier 6 after the sensor output V_{SOUT} is read out from the pixel region 1 is explained below, with reference to FIGS. 11 and 12. FIG. 11 is a circuit diagram illustrating an internal configuration of the sensor pixel readout circuit 41. FIG. 12 is a waveform diagram showing a relationship among the readout signal V_{RWS}, the sensor output V_{SOUT}, and an output V_{S} of the sensor pixel readout circuit. As described above, when the readout signal rises to the high level V_{RWS. H}, the thin film transistor M2 becomes conductive, whereby the thin film transistors M2 and M3 form a source follower amplifier. This allows the sensor output V_{SOUT} to be accumulated in a sample capacitor C_{SAM} of the sensor pixel readout circuit 41. Therefore, after the readout signal falls to the low level V_{RWS. L}, an output voltage V_{S} from the sensor pixel readout circuit 41 to the sensor column amplifier 42 is maintained at a level equal to a peak value of the sensor output V_{SOUT} during a period (t_{row}) while the row concerned is selected, as shown in FIG. 12.

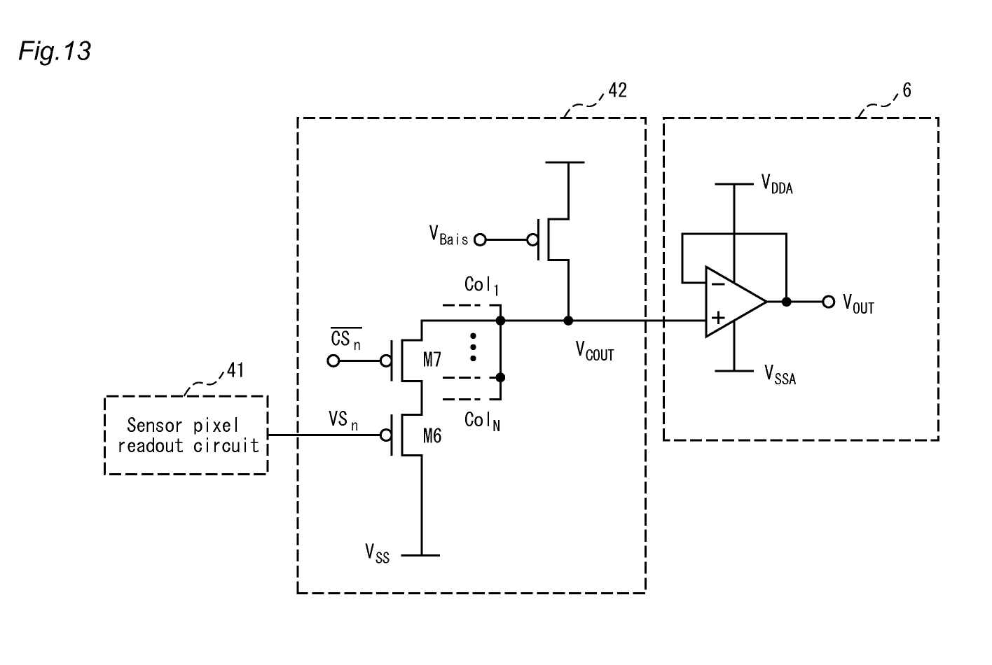

Next, an operation of the sensor column amplifier 42 is explained below, with reference to FIG. 13. As shown in FIG. 13, the respective output voltages V_{Sj} (j=1 to N) of the columns are input from the sensor pixel readout circuit 41 to the N column amplifiers of the sensor column amplifier 42. As shown in FIG. 13, each column amplifier is composed of thin film transistors M6 and M7. Column select signals C_{Sj} generated by the sensor column scanning circuit 43 become ON sequentially with respect to the N columns during a selection period (t_{row}) for one row, respectively, so that the thin film transistor M6 of concerned one of the N column amplifiers in the sensor column amplifier 42 is turned on. Then, only concerned one of the output voltages V_{Sj} (j=1 to N) of the columns is output via the thin film transistor M6 concerned, as an output V_{COUT} from the sensor column amplifier 42. The buffer amplifier 6 further amplifies V_{COUT} output from the sensor column amplifier 42, and outputs the same as a panel output (optical sensor signal) V_{OUT} to the signal processing circuit 8.

It should be noted that the sensor column scanning circuit 43 may scan the optical sensor columns one by one as described above, but the configuration is not limited to this. The sensor column scanning circuit 43 may have a configuration for performing interlaced-scanning of columns of the optical sensors. Alternatively, the sensor column scanning circuit 43 may be formed as a scanning circuit of multiphase driving, for example, four-phase driving.

With the above-described configuration, the display device according to the present embodiment obtains a panel output V_{OUT} according to an amount of light received by the photodiode D1 formed in each pixel in the pixel region 1. The panel output V_{OUT} is sent to the signal processing circuit 8, is A/D converted there, and is accumulated in a memory (not shown) as panel output data. This means that the same number of sets of panel output data as the number of pixels (the number of the optical sensors) in the pixel region 1 are accumulated in this memory. The signal processing circuit 8 performs various types of signal processing operations such as image capture and detection of a touched region, using the panel output data accumulated in the memory. It should be noted that in the present embodiment, the same number of sets of panel output data as the number of pixels (the number of optical sensors) in the pixel region 1 are accumulated in the memory of the signal processing circuit 8, but the number of sets of panel output data accumulated therein is not necessarily the same as the number of pixels, with consideration to limitations such as a memory capacity.

As described above, in the present embodiment, the amplitude of the readout signal is adjusted according to the degree of divergence between the gray scale data of the output signal voltage Vout_D2 and the standard offset value. This makes it possible to obtain a signal with an offset due to a dark current or the like being eliminated, as the output signal voltage Vout_D1 from the photodetecting sensor driven according to the adjusted readout signal.

According to the present embodiment, subtraction of an output of the reference sensor from an output of the photodetecting sensor as in the conventional configuration is not needed. Therefore, a problem that the dynamic range of the sensor output is narrowed does not arise. This makes it possible to realize a display device that is capable of detecting an intensity of external light with high precision without being influenced by ambient temperature, and that is provided with an optical sensor having a wide dynamic range.

### Embodiment 2

Hereinafter, Embodiment 2 of the present invention is explained. The members having the same functions as those of Embodiment 1 are denoted by the same reference numerals as those in Embodiment 1, and explanations of the same are omitted. This applies to the other embodiments to be described later.

A display device according to the present embodiment is different from the display device according to Embodiment 1 in the point that a variable capacitor is used as the capacitor of the optical sensor, and the point that the compensation circuit 60 adjusts, not the amplitude of the readout signal, but the potential of the low level of the readout signal.

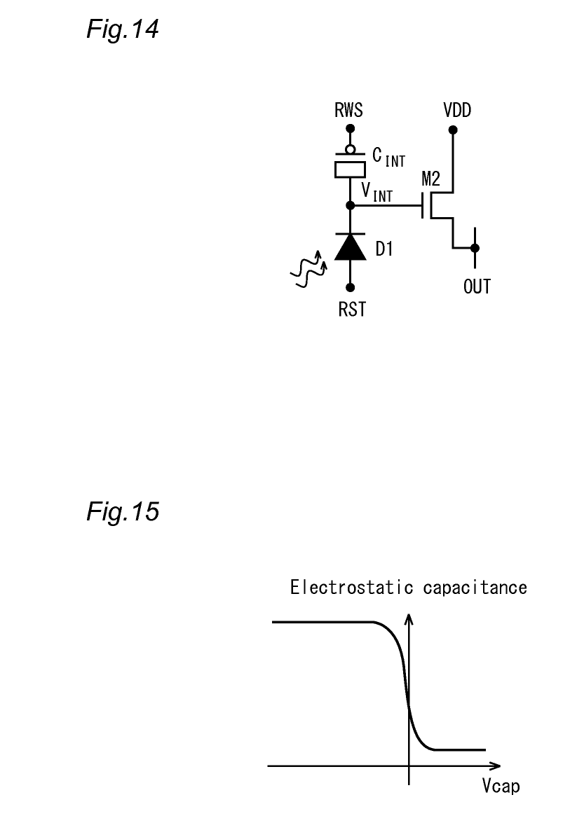

FIG. 14 is an equivalent circuit diagram of a photodetecting sensor according to Embodiment 2. As shown in FIG. 14, the photodetecting sensor according to the present embodiment is different from the photodetecting sensor according to Embodiment 1 in the point that the capacitor C_{INT} is a variable capacitor. A reference sensor according to the present embodiment also has a variable capacitor, as a capacitor C_{INT}, which is identical to that of the photodetecting sensor, though illustration of the same is omitted. As the variable capacitor, for example, a p-channel MOS capacitor, an n-channel MOS capacitor, or the like can be used.

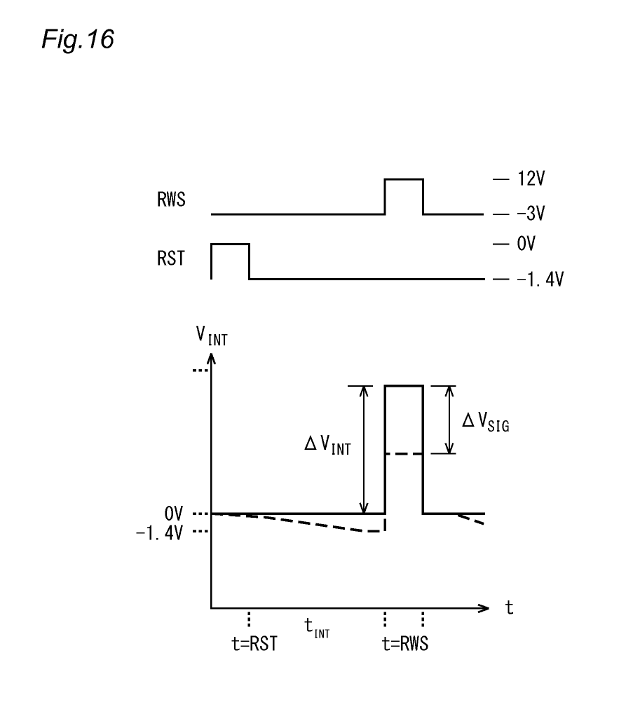

FIG. 15 is a C-V characteristic diagram of the variable capacitor C_{INT} of the present embodiment. In FIG. 15, the horizontal axis indicates an interelectrode voltage V_{CAP} of the variable capacitor C_{INT}, and the vertical axis indicates an electrostatic capacitance. As shown in FIG. 15, the variable capacitor C_{INT} is characterized in that it has an electrostatic capacitance that is constant when the interelectrode voltage V_{CAP} is small, but exhibits a precipitous change immediately before and after the interelectrode voltage V_{CAP} reaches a threshold value. Therefore, the characteristics of the variable capacitor C_{INT} can be varied dynamically with the potential of the readout signal supplied from the line RWS. The use of the variable capacitor C_{INT} having such characteristics allows the optical sensor according to the present embodiment to read out an amplified value of a change in the potential of the accumulation node during an integration period T_{INT}, as shown in FIG. 16.

The example shown in FIG. 16 is merely one specific example, in which the low level V_{RST. L} of the reset signal is −1.4 V, and the high level V_{RST. H} of the reset signal is 0 V. The low level V_{RWS. L} of the readout signal is −3 V, and the high level V_{RWS. H} of the readout signal is 12 V. In FIG. 16 also, the waveform indicated by the solid line represents variation of the potential V_{INT} in the case where light incident on the photodiode D1 is small in amount, and the waveform indicated by the broken line represents variation of the potential V_{INT} in the case where light at a saturation level is incident on the photodiode D1. ΔV_{SIG} is a potential difference proportional to an amount of light incident on the photodiode D1. In the optical sensor according to the present embodiment, a change in the potential of the accumulation node during the integration period T_{INT} in the case where light at a saturation level is incident is relatively small, but this potential V_{INT} of the accumulation node is amplified and read out during the readout period (the period while the potential of the readout signal is at the high level V_{RWS. H}).

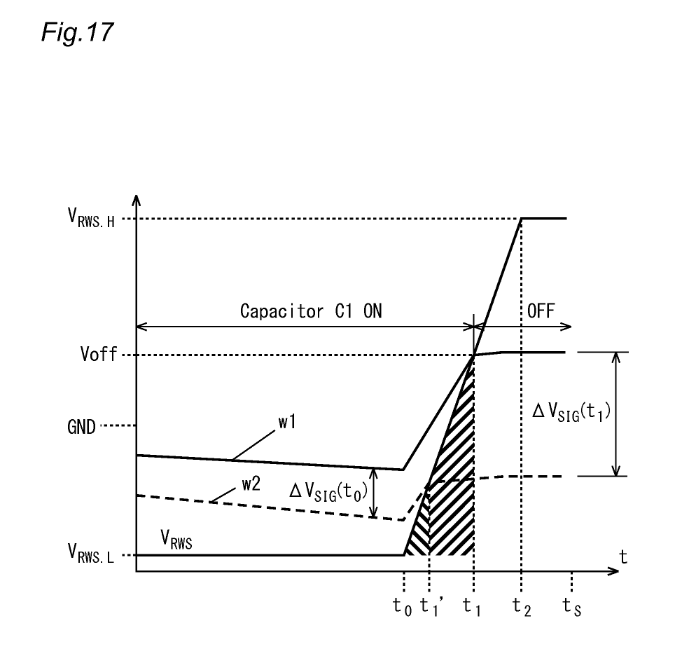

Here, details of the readout operation of the optical sensor according to the present embodiment are explained below, with reference to FIG. 17. FIG. 17 is a waveform diagram showing variation of the potential V_{INT} of the accumulation node from the end of the integration period over the readout period. In FIG. 17, the waveform w1 indicated by a solid line represents variation of the potential V_{INT} in the case where light incident on the photodiode D1 is small in amount. The waveform w2 indicated by the broken line represents variation of the potential V_{INT} in the case where light is incident on the photodiode D1. The time to is a time at which the readout signal supplied from the line RWS starts rising from the low level V_{RWS. L}. The time t₂ is a time at which the readout signal reaches the high level V_{RWS. H}. The time t_{S} is a time at which the transistor M2 is turned on and sampling of a sensor output is carried out. The time t₁ is a time at which the readout signal reaches the threshold voltage V_{off} of the variable capacitor C_{INT}. The time t₁′ is a time at which the readout signal reaches the threshold voltage V_{off} of the variable capacitor C_{INT} in the case where light is incident on the photodiode D1 (in the case of the waveform w2). In other words, the variable capacitor C_{INT} has operation characteristics that are altered according to the magnitude relation between the potential supplied from the readout signal line RWS and the threshold voltage V_{off}.

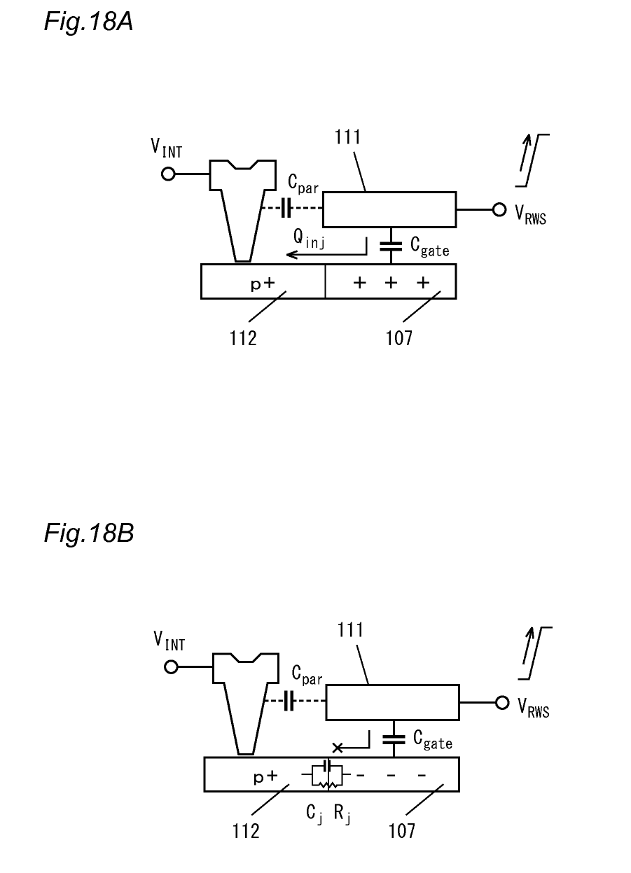

FIGS. 18A and 18B are cross-sectional schematic diagrams showing a difference in the transfer of charges according to the potential of the gate electrode in the variable capacitor C_{INT}, in the case where the variable capacitor C_{INT} is formed with a p-channel MOS capacitor. The variable capacitor C_{INT} is composed of a gate electrode 111, an n⁻ region 107 formed in a silicon film, and an insulative film (not shown) formed therebetween, as shown in FIGS. 18A and 18B. The region 112 shown in FIGS. 18A and 18B is a p⁺ region formed by doping a p-type impurity such as boron into the n-type silicon film.

As shown in FIGS. 17, 18A and 18B, the variable capacitor C_{INT} is always in an ON state at any time before the time t₁, and after the time t₁, the capacitor C_{INT} is in an OFF state. In other words, while the potential of the line RWS is at or below the threshold voltage V_{off}, transfer of charges Qᵢₙⱼ occurs under the gate electrode 111 as shown in FIG. 18A. On the other hand, when the potential of the line RWS exceeds the threshold voltage V_{off}, there is no transfer of charges Qᵢₙⱼ, under the gate electrode 111 as shown in FIG. 18B. As described so far, the potential V_{INT} (tₛ) of the accumulation node at a sampling time tₛ after the potential of the readout signal supplied from the readout signal line RWS reaches the high level V_{RWS. H} is as expressed by the formula shown below. It should be noted that ΔV_{INT} shown in FIG. 16 is equivalent to a difference between V_{INT} (t₀) and C_{INT}(tₛ), which is equal to Qᵢₙⱼ/C_{INT}.

$$\begin{matrix} [ Mathematical Formula 1 ] & \\ \begin{matrix}{V}_{INT} ( {t}_{S} ) = {V}_{INT} ( {t}_{0} ) + \frac{{Q}_{inj}}{{C}_{TOTAL}} \\ = {V}_{INT} ( {t}_{0} ) + \int \frac{{C}_{INT}}{{C}_{TOTAL}} \cdot d V \\ = {V}_{INT} ( {t}_{0} ) + [ \begin{matrix}{\int }_{{V}_{RWS} ( L )}^{Voff} \frac{{C}_{INT}}{{C}_{INT} + {C}_{TFT} + {C}_{DIODE}} \cdot d V + \\ {\int }_{Voff}^{{V}_{RWS} ( H )} \frac{{C}_{INT}^{′}}{{C}_{INT}^{′} + {C}_{TFT} + {C}_{DIODE}} \cdot d V\end{matrix} ]\end{matrix} & \\ where & \\ {C}_{INT} = {C}_{par} + {C}_{gate} & \\ {C}_{INT}^{′} = {C}_{par} + \frac{{C}_{gate} \cdot {C}_{j}}{{C}_{gate} + {C}_{j}} & \end{matrix}$$

As shown in FIG. 17, with the optical sensor (photodetecting sensor) according to the present embodiment, ΔV_{INT}(t₀) at the end of the integration period is amplified to ΔV_{SIG}(t₁). This causes a potential difference of the accumulation node due to a difference of illuminance on the light receiving face after boosting to be greater than a potential difference of the same at the end of the integration period. For example, a difference between a potential of the accumulation node after the boosting during the readout period in the case of the dark state and a potential of the accumulation node after boosting during the readout period in the case where light at a saturation level is incident is greater than a difference between a potential of the accumulation node at the end of the integration period in the case of the dark state and a potential of the accumulation node at the end of the integration period in the case where light at a saturation level is incident. Therefore, an optical sensor having a high sensitivity and a high S/N ratio can be realized.

It should be noted that the reference sensor in the present embodiment is shielded so as not to receive external light. This results in that only dark current components due to temperature changes, ambient light (backlight, etc.), or changes with time are detected.

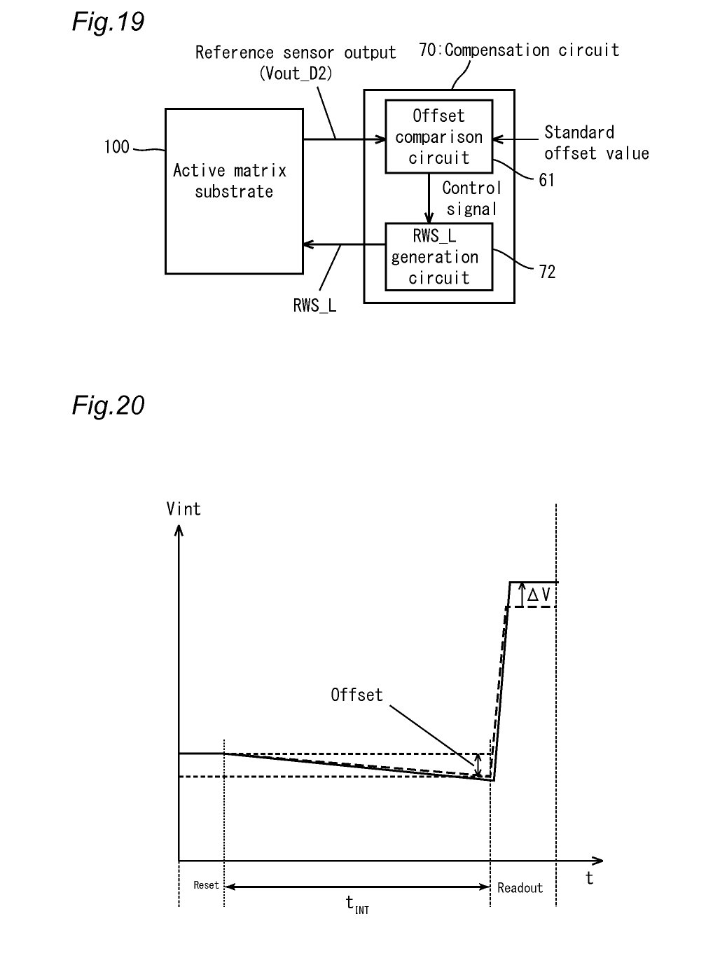

FIG. 19 is a block diagram showing a schematic configuration of a compensation circuit 70 according to the present embodiment. The compensation circuit 70 is provided outside the active matrix substrate 100 in the example of FIG. 19 (e.g., in the signal processing circuit 8), but it may be provided in the sensor row driver instead. The compensation circuit 70 includes an offset comparison circuit 61, and an RWS_L generation circuit 72. The offset comparison circuit 61 compares an output signal voltage Vout_D2 from the reference optical sensor and a predetermined standard offset value, determines a degree of divergence therebetween, and outputs a control signal corresponding to the divergence degree thus determined, to the RWS_L generation circuit 72. The RWS_L generation circuit 72 controls the potential of the low level (V_{RWS.L}) of the readout signal (RWS), based on the control signal from the offset comparison circuit 61. More specifically, the RWS_L generation circuit 72 decreases the potential of V_{RWS.L} by α, according to a degree of a divergence between the output signal Vout_D2 of the reference sensor and the standard offset value. In other words, this offset potential α is the value determined by the offset comparison circuit 61 according to the degree of divergence between the output signal Vout_D2 of the reference sensor and the standard offset value.

FIG. 20 is a signal waveform diagram showing potential variation (broken line) of V_{INT} before the correction by the compensation circuit 70, and potential variation (solid line) of V_{INT} in the case where the potential of the low level V_{RWS.L} of the readout signal is decreased by α. As shown in FIG. 20, the potential of the low level V_{RWS.L} of the readout signal is decreased by α, and thereby the potential of V_{INT} increases by a voltage ΔV corresponding to the offset α.

As described above, in the present embodiment, the potential of the low level of the readout signal is adjusted according to the degree of divergence between the gray scale data of the output signal voltage Vout_D2 and the standard offset value. As a result, during the integration period after this, a signal with an offset due to a dark current or the like being eliminated can be obtained as an output signal voltage Vout_D1 from the photodetecting sensor actuated based on the readout signal after the adjustment.

Further, according to the present embodiment, subtraction of an output of the reference sensor from an output of the photodetecting sensor as in the conventional configuration is not needed. Therefore, a problem that the dynamic range of the sensor output is narrowed does not arise. This makes it possible to realize a display device that is capable of detecting an intensity of external light with high precision without being influenced by ambient temperature, and that is provided with an optical sensor having a wide dynamic range.

### Embodiment 3

Hereinafter, Embodiment 3 of the present invention is explained.

In the display device according to the present embodiment, the configurations of the optical sensors (the photodetecting sensor and the reference sensor) are identical to those of Embodiment 1. The display device of the present embodiment, however, is different from Embodiment 1 regarding the configuration of the compensation circuit. More specifically, the display device of the present embodiment includes a compensation circuit 80 that adjusts a potential of the high level of the reset signal, in place of the compensation circuit 60 that adjusts the amplitude of the readout signal, which is disclosed in Embodiment 1.

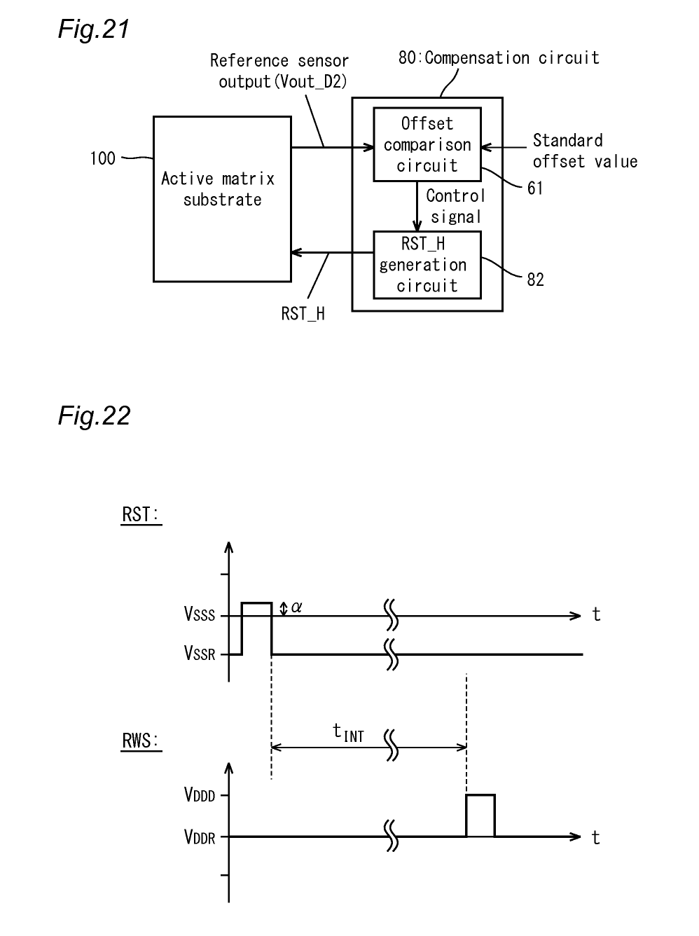

FIG. 21 is a block diagram showing a schematic configuration of the compensation circuit 80 of the present embodiment. The compensation circuit 80 is provided outside the active matrix substrate 100 (e.g., in the signal processing circuit 8) in the example of FIG. 21, but it may be provided in the sensor row driver 5 instead. The compensation circuit 80 includes an offset comparison circuit 61, and an RST_H generation circuit 82. The offset comparison circuit 61 compares an output signal voltage Vout_D2 from the reference optical sensor and a predetermined standard offset value, determines a degree of divergence therebetween, and outputs a control signal corresponding to the divergence degree thus determined, to the RST_H generation circuit 82. The RST_H generation circuit 82 adjusts the potential of the high level (V_{RST.H}) of the reset signal based on the control signal from the offset comparison circuit 61.

FIG. 22 is a waveform diagram showing an exemplary readout signal after adjustment by the compensation circuit 80. As shown in FIG. 22, the RST_H generation circuit 82 increases the potential of the high level V_{RST.H} of the reset signal, which is V_{SSS} before adjustment (see FIG. 4), by α. This offset potential α is a value determined by the offset comparison circuit 61 according to the degree of divergence between the output signal voltage Vout_D2 of the reference sensor and the standard offset value.

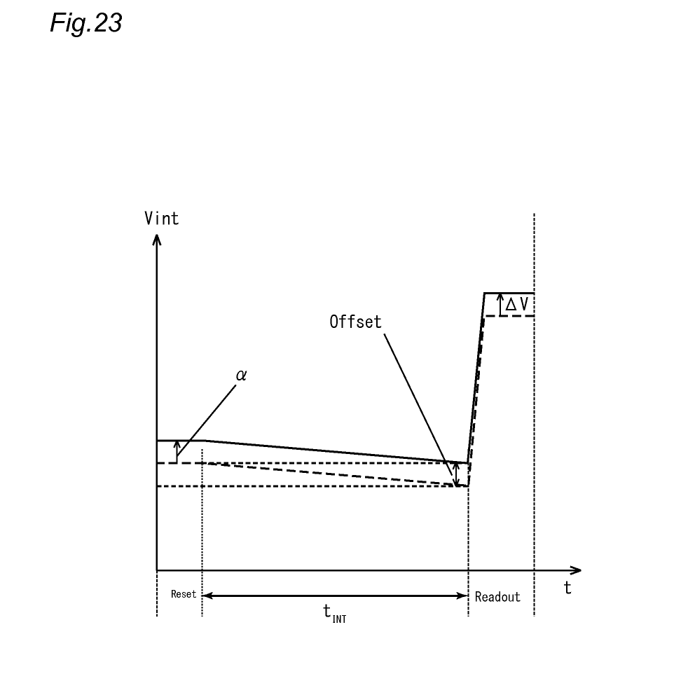

FIG. 23 is a signal waveform diagram showing potential variation (broken line) of V_{INT} in the case where the potential of the high level V_{RST.H} of the reset signal is V_{SSS}, and potential variation (solid line) of V_{INT} in the case where the potential of the high level V_{RST.H} of the reset signal is (V_{SSS}+α. As shown in FIG. 23, the potential of the high level V_{RST.H} of the reset signal is set to (V_{SSS}+α), and thereby the potential of V_{INT} increases by a voltage ΔV corresponding to the offset α.

As described above, by setting the potential of the high level V_{RST.H} of the reset signal to (V_{SSS}+α) according to the degree of divergence between the gray scale data of the output signal voltage Vout_D2 and the standard offset value, a signal with an offset due to a dark current or the like being eliminated can be obtained as an output signal voltage Vout_D1.

Further, according to the present embodiment, subtraction of an output of the reference sensor from an output of the photodetecting sensor as in the conventional configuration is not needed. Therefore, a problem that the dynamic range of the sensor output is narrowed does not arise. This makes it possible to realize a display device that is capable of detecting an intensity of external light with high precision without being influenced by ambient temperature, and that is provided with an optical sensor having a wide dynamic range.

### Exemplary Modification 1 of Embodiment 3

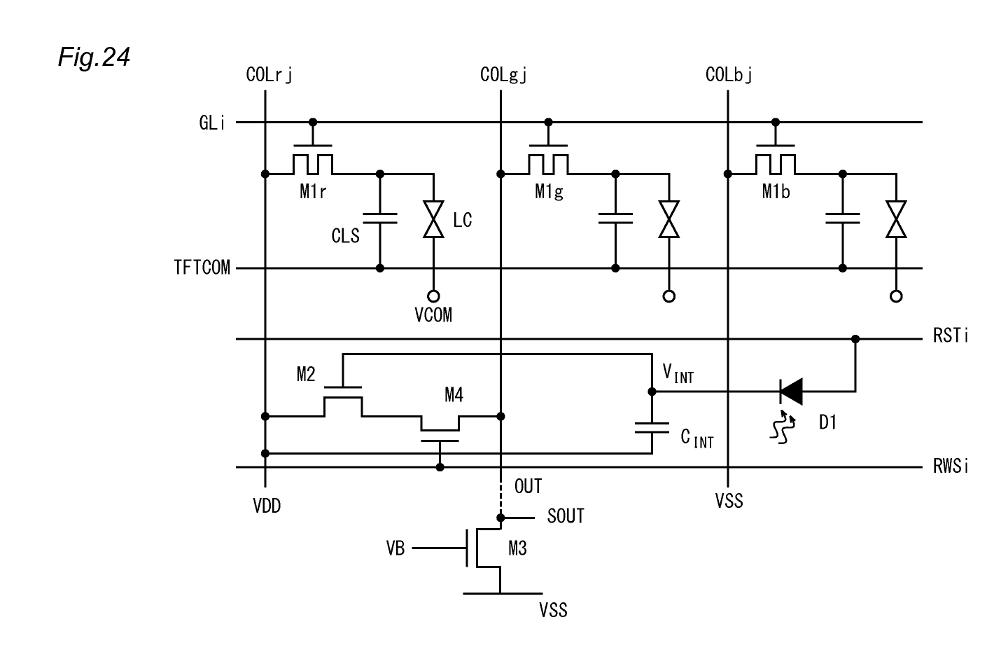

As an exemplary modification of the circuit configuration explained above as Embodiment 3, the following configuration is feasible. FIG. 24 is an equivalent circuit diagram showing a configuration of one pixel in a display device according to Exemplary Modification 1 of Embodiment 3. As shown in FIG. 24, the optical sensor of the display device according to Exemplary Modification 1 includes a photodiode D1, a capacitor C_{INT}, and a thin-film transistor M2, as well as a thin-film transistor M4 additionally. It should be noted that this modification is identical to Embodiment 3 in the point that each of some pixels in the pixel region 1 has the reference sensor in which the photodiode D2 provided with the light shielding film LS is provided in place of the photodiode D1.

In the optical sensor according to Exemplary Modification 1, one electrode of the capacitor C_{INT} is connected between a cathode of the photodiode D1 and a gate electrode of the thin film transistor M2, and the other electrode of the capacitor C_{INT} is connected to the line VDD. A drain of the thin film transistor M2 is connected to the line VDD, and a source thereof is connected to a drain of the thin film transistor M4. A gate of the thin film transistor M4 is connected to the readout signal line RWS. A source of the thin film transistor M4 is connected to the line OUT. It should be noted that this example shown in herein has a configuration in which one of the electrodes of the capacitor C_{INT} and the drain of the thin film transistor M2 are connected to a common constant voltage line (line VDD), but the configuration may be such that these are connected to different constant voltage lines, respectively.

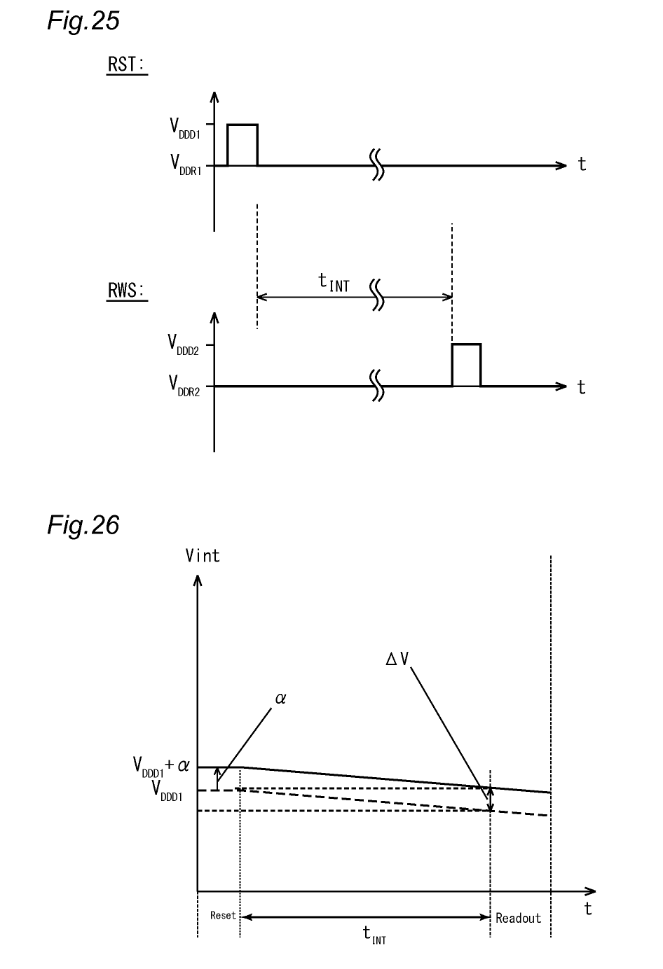

Here, operations of the optical sensor according to Exemplary Modification 1 are explained with reference to FIGS. 25 and 26.

FIG. 25 is a timing chart showing a waveform of a reset signal supplied from the reset signal line RST to the optical sensor, and a waveform of the readout signal supplied from the readout signal line RWS thereto. FIG. 26 is a waveform diagram showing variation of V_{INT} in the reset period, the integration period, and the readout period, in the optical sensor of Exemplary Modification 1. It should be noted that the broken line in FIG. 26 indicates variation of V_{INT} before correction of the high level potential of the reset signal, and the solid line in FIG. 26 indicates variation of V_{INT} after correction.

The high level V_{RST.H} of the reset signal is set to a potential at which the thin film transistor M2 is turned on. In the example shown in FIG. 25, the high level V_{RST.H} of the reset signal is equal to V_{DDD1}, and the low level V_{RST.L} thereof is equal to V_{DDR1}. Further, the high level V_{RWS.H} of the readout signal is equal to V_{DDD2}, and the low level V_{RWS.L} thereof is equal to V_{DDR2}. It should be noted that these exemplary voltages are merely examples, and the potentials of the respective levels can be set appropriately.

First, when the reset signal supplied form the sensor row driver 5 to the reset signal line RST rises from the low level to the high level, the photodiode D1 is forward-biased. Here, the thin film transistor M2 is turned on, but since the readout signal is at the low level and the thin film transistor M4 is in an OFF state, there is no output to the line OUT.

Next, the reset signal returns to the low level V_{RST.L} (i.e., V_{DDR1}), and thereby a photoelectric current integration period (t_{INT} shown in FIGS. 25 and 26) starts. During the integration period, current flows out of the capacitor C_{INT} due to the photodiode, whereby the capacitor C_{INT} is discharged. Here, in the pixel having the photodiode D1, a sum of a photoelectric current I_{PHOTO} generated by incident light and a dark current I_{DARK} flows out of the capacitor C_{INT}. On the other hand, in the pixel having the photodiode D2, only the dark current I_{DARK} flows out of the capacitor C_{INT}.

During the integration period as well, V_{INT} decreases from the reset potential by a degree according to an intensity of incident light. As the thin film transistor M4 is in an OFF state, however, there is no sensor output to the line OUT. It should be noted that the sensor circuit is desirably designed so that the sensor output is minimized in the case where light at the upper limit of illuminance to be detected is projected on the photodiode D1, i.e., the potential (V_{INT}) of the gate electrode of the thin film transistor M2 in this case slightly exceeds the threshold value. In this design, when light having an illuminance exceeding the upper limit of illuminance to be detected is projected on the photodiode D1, the value of V_{INT} falls to below the threshold value of the thin film transistor M2, thereby turning the thin film transistor M2 off. As a result, there is no sensor output to the line OUT.

When the integration period ends, as shown in FIG. 25, the readout signal rises, whereby the readout period starts. When the readout signal rises to the high level, the thin film transistor M4 is turned on. This causes an output of the thin film transistor M2 to be output to the line OUT via the thin film transistor M4. Here, the thin film transistor M2, together with the thin film transistor M3 for bias provided at an end of the line OUT at each column, functions as a source follower amplifier. In other words, in the photodetecting sensor provided with the photodiode D1, a voltage obtained by amplifying an integral of a sum of the photoelectric current I_{PHOTO} generated by light incident on the photodiode D1 during an integration period and the dark current I_{DARK} is obtained as an output signal voltage Vout_D1 from the output line SOUT from the drain of the thin film transistor M3. Further, from the reference sensor provided with the photodiode D2, a voltage obtained by amplifying an integral of the dark current I_{DARK} during the integration period is obtained as an output signal voltage Vout_D2 from the output line SOUT from the drain of the thin film transistor M3.

In this Exemplary Modification 1 as well, as is explained in the description of Embodiment 3, the compensation circuit 80 adjusts by increasing the potential of the high level of the reset signal by a degree (α) corresponding to the offset, based on the output signal voltage Vout_D2 from the reference sensor provided with the photodiode D2. In other words, as shown in FIG. 26, the potential of the high level V_{RST.H} of the reset signal is set to (V_{DDD1}+α), and thereby the potential of V_{INT} increases by a voltage ΔV corresponding to the offset α.

As described above, by setting the potential of the high level V_{RST.H} of the reset signal to (V_{DDD1}+α) according to the degree of divergence between the gray scale data of the output signal voltage Vout_D2 and the standard offset value, a signal with an offset due to a dark current or the like being eliminated can be obtained as an output signal voltage Vout_D1.

As a result, in Exemplary Modification 1 as well, it is possible to detect an intensity of external light with high precision without being influenced by ambient temperature, and to realize a display device provided with an optical sensor having a wide dynamic range, as is the case with Embodiment 3.

### Embodiment 4

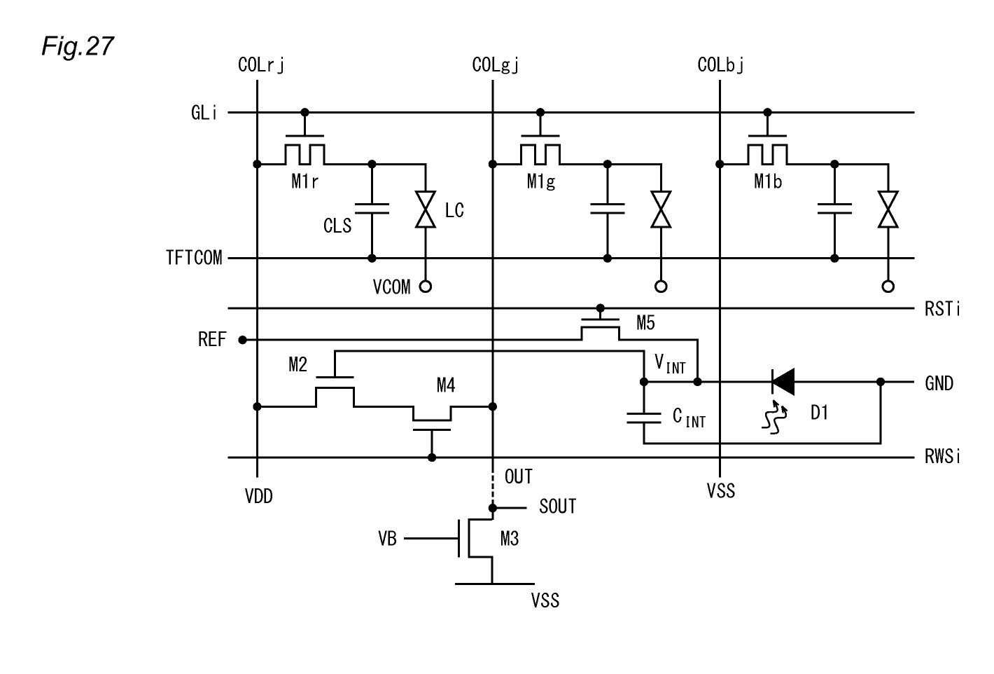

Embodiment 4 is explained below. FIG. 27 is an equivalent circuit diagram showing a configuration of one pixel in a display device according to Embodiment 4. As shown in FIG. 27, the optical sensor of the display device according to Exemplary Modification 2 includes a photodiode D1, a capacitor CI r, and a thin-film transistor M2, as well as thin-film transistors M4 and M5 additionally. It should be noted that this embodiment is identical to Embodiment 1 in the point that in each of some pixels in the pixel region 1, the reference sensor having the photodiode D2 provided with the light shielding film LS is provided in place of the photodetecting sensor provided with the photodiode D1.

In the optical sensor according to Embodiment 4, one electrode of the capacitor C_{INT} is connected between a cathode of the photodiode D1 and a gate electrode of the thin film transistor M2. The other electrode of the capacitor C_{INT} is connected to GND. A drain of the thin film transistor M2 is connected to the line VDD, and a source thereof is connected to a drain of the thin film transistor M4. A gate of the thin film transistor M4 is connected to the readout signal line RWS. A source of the thin film transistor M4 is connected to the line OUT. A gate of the thin film transistor M5 is connected to the reset signal line RST, a drain thereof is connected to the line REF, and a source thereof is connected to a cathode of the photodiode D1. The line REF supplies the reset level potential V_{REF}.

Here, operations of the optical sensor according to the present embodiment are explained. It should be noted that in the optical sensor of the present embodiment, the waveforms of the reset signal supplied from the reset signal line RST and the readout signal supplied from the readout signal line RWS are identical those shown in FIG. 25, which is referred to in conjunction with Exemplary Modification 1 of Embodiment 3. FIG. 29 is a waveform diagram showing variation of V_{INT} in the reset period, the integration period, and the readout period, in the optical sensor of present embodiment. The broken line in FIG. 29 indicates variation of V_{INT} before correction of the reset level potential V_{REF}, and the solid line in FIG. 29 indicates variation of V_{INT} after correction.

The high level V_{RST.H} of the reset signal is set to a potential at which the thin film transistor M5 is turned on. In the example shown in FIG. 25, the high level V_{RST.H} of the reset signal is equal to V_{DDD1}, and the low level V_{RST.L} thereof is equal to V_{DDR1}. Further, the high level V_{RWS.H} of the readout signal is equal to V_{DDD2}, and the low level V_{RWS.L} thereof is equal to V_{DDR2}. It should be noted that these exemplary voltages are merely examples, and the potentials of the respective levels can be set appropriately.

First, when the reset signal supplied form the sensor row driver 5 to the reset signal line RST rises from the low level to the high level, the thin film transistor M5 is turned on. This causes the potential V_{INT} to be reset to V_{REF}.

Next, the reset signal returns to the low level V_{RST.L} (i.e., V_{DDR1}), and thereby a photoelectric current integration period starts. When the reset signal falls to the low level, the thin film transistor M5 is turned off. Here, since the anode potential of the photodiode D1 is GND, and the potential of the cathode thereof is V_{INT}=V_{REF}, a reverse bias is applied to the photodiode D1. During the integration period, current flows out of the capacitor C_{INT} due to the photodiode, whereby the capacitor C_{INT} is discharged. Here, in the photodetecting sensor provided with the photodiode D1, a sum of a photoelectric current I_{PHOTO} generated by incident light and a dark current I_{DARK} flows out of the capacitor C_{INT}. On the other hand, in the reference sensor provided with the photodiode D2, only the dark current I_{DARK} flows out of the capacitor C_{INT}. In the photodetecting sensor provided with the photodiode D1, during the integration period, V_{INT} decreases from the reset potential (V_{RST.H}=V_{REF} in this example) by a degree according to an intensity of incident light. As the thin film transistor M4 is in an OFF state, however, there is no sensor output to the line OUT. It should be noted that the sensor circuit is desirably designed so that the sensor output is minimized in the case where light at the upper limit of illuminance to be detected is projected on the photodiode D1, i.e., the potential (V_{INT}) of the gate electrode of the thin film transistor M2 in this case slightly exceeds the threshold value. In this design, when light having an illuminance exceeding the upper limit of illuminance to be detected is projected on the photodiode D1, the value of V_{INT} falls to below the threshold value of the thin film transistor M2, thereby turning the thin film transistor M2 off. As a result, there is no sensor output to the line OUT.

When the integration period ends, as shown in FIG. 25, the readout signal rises, whereby the readout period starts. When the readout signal rises to the high level, the thin film transistor M4 is turned on. This causes an output of the thin film transistor M2 to be output to the line OUT via the thin film transistor M4. Here, the thin film transistor M2, together with the thin film transistor M3 for bias provided at an end of the line OUT at each column, functions as a source follower amplifier. In other words, from the photodetecting sensor provided with the photodiode D1, a voltage obtained by amplifying an integral of a sum of the photoelectric current I_{PHOTO} generated by light incident on the photodiode D1 during an integration period and the dark current I_{DARK} is obtained, as an output signal voltage Vout_D1 from the output line SOUT from the drain of the thin film transistor M3. Further, from the reference sensor provided with the photodiode D2, a voltage obtained by amplifying an integral of amplifying an integral of the dark current I_{DARK} during the integration period is obtained as an output signal voltage Vout_D2 from the output line SOUT from the drain of the thin film transistor M3.

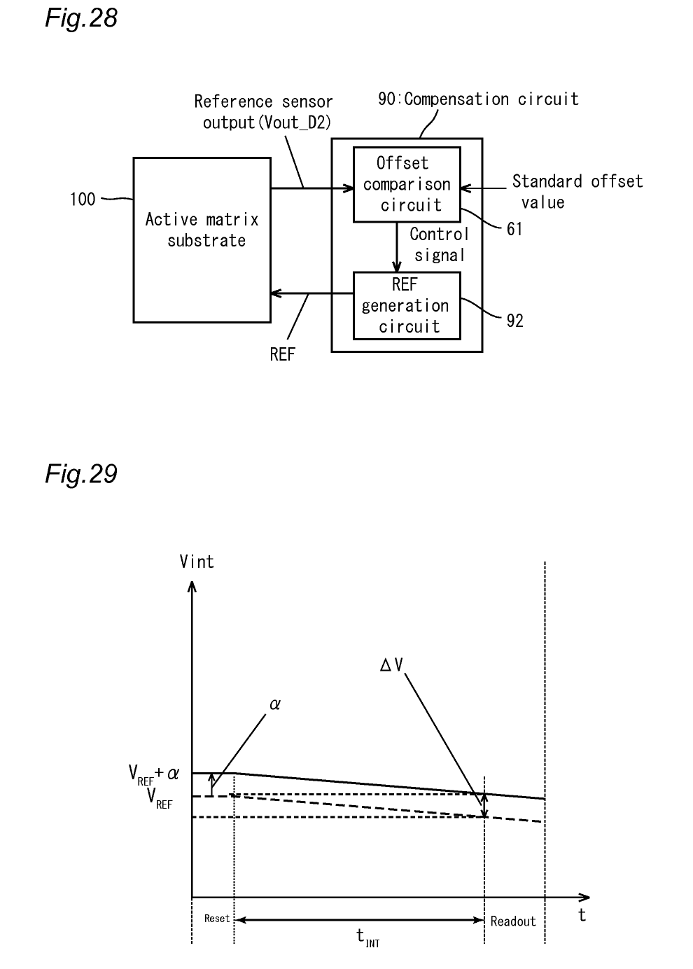

FIG. 28 is a block diagram showing a schematic configuration of a compensation circuit 90 provided in the display device according to Embodiment 4. The compensation circuit 90 is provided outside the active matrix substrate 100 (e.g., in the signal processing circuit 8) in the example of FIG. 28, but it may be provided in the sensor row driver 5 instead. The compensation circuit 90 includes an offset comparison circuit 61, and an REF generation circuit 92. The offset comparison circuit 61 compares an output signal voltage Vout_D2 from the reference optical sensor and a predetermined standard offset value, determines a degree of divergence therebetween, and outputs a control signal corresponding to the divergence degree thus determined, to the REF generation circuit 92. The REF generation circuit 92 adjusts the reset level potential V_{REF} supplied from the line REF, according to the control signal from the offset comparison circuit 61. In other words, the REF generation circuit 92 sets the reset level potential V_{REF} so that the reset level potential V_{REF} is increased by a degree (α) corresponding to the offset.

FIG. 29 is a signal waveform diagram showing potential variation (broken line) of V_{INT} before the reset level potential V_{REF} is adjusted, and potential variation (solid line) of V_{INT} after the reset level potential V_{REF} is increased by α. As shown in FIG. 29, by increasing the reset level potential V_{REF} by α, the potential of V_{INT} is increased by a voltage ΔV corresponding to the offset α.

As described above, by setting the reset level potential V_{REF} increased by a according to the degree of divergence between the gray scale data of the output signal voltage Vout_D2 and the standard offset value, a signal with an offset due to a dark current or the like being eliminated can be obtained as an output signal voltage Vout_D1.

Further, according to the present embodiment, subtraction of an output of the reference sensor from an output of the photodetecting sensor as in the conventional configuration is not needed. Therefore, a problem that the dynamic range of the sensor output is narrowed does not arise. This makes it possible to realize a display device that is capable of detecting an intensity of external light with high precision without being influenced by ambient temperature, and that is provided with an optical sensor having a wide dynamic range.

### Embodiment 5

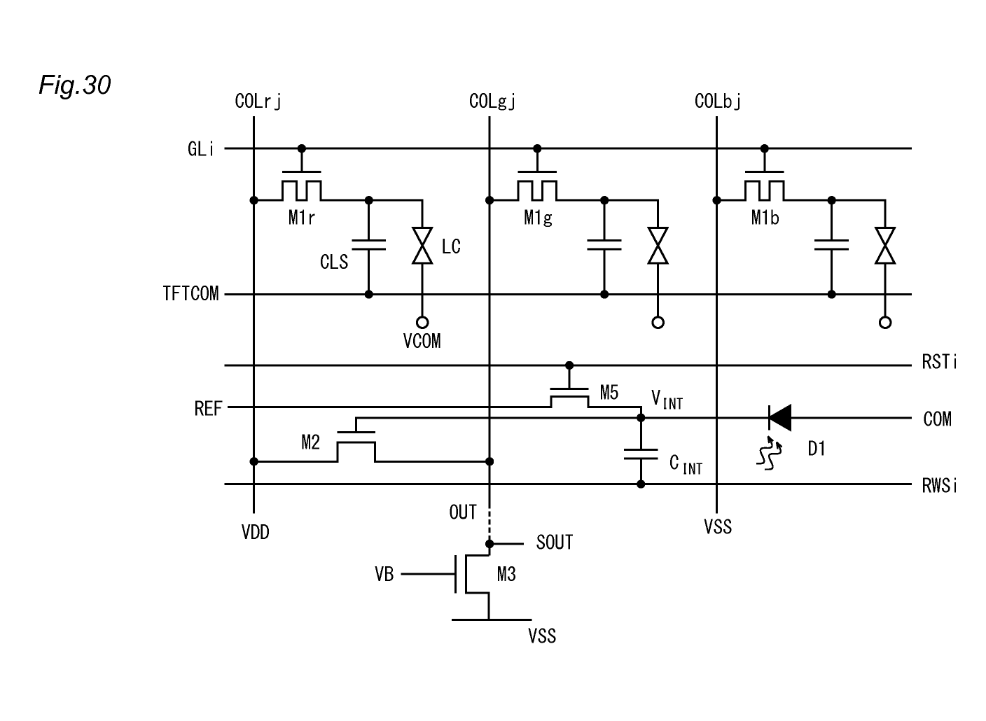

Embodiment 5 is explained below. FIG. 30 is an equivalent circuit diagram showing a configuration of one pixel in a display device according to Embodiment 5. As shown in FIG. 30, the optical sensor of the display device according to the present embodiment includes a photodiode D1, a capacitor C_{INT}, and a thin-film transistor M2, as well as a thin-film transistor M5 additionally. It should be noted that this embodiment is identical to Embodiment 1 in the point that in each of some pixels in the pixel region 1, the reference sensor that includes the photodiode D2 provided with the light shielding film LS is provided in place of the photodetecting sensor provided with the photodiode D1.

In the optical sensor according to Embodiment 5, one electrode of the capacitor C_{INT} is connected between a cathode of the photodiode D1 and a gate electrode of the thin film transistor M2. The other electrode of the capacitor C_{INT} is connected to the readout signal line RWS. A drain of the thin film transistor M2 is connected to the line VDD, and a source thereof is connected to the line OUT. A gate of the thin film transistor M5 is connected to the reset signal line RST, a drain thereof is connected to the line REF, and a source thereof is connected to a cathode of the photodiode D1. The line REF supplies the reset level potential V_{REF}. An anode of the photodiode D1 is connected to COM that supplies a constant voltage.

In the optical sensor of the present embodiment, the waveform of the reset signal supplied from the reset signal line RST and the waveform of the readout signal supplied from the readout signal line RWS are identical to those shown in FIG. 4, which is referred to in conjunction with Embodiment 1. The display device according to the present embodiment includes the compensation circuit 60 shown in FIG. 6, which is referred to in conjunction with Embodiment 1. As is the case with Embodiment 1, the compensation circuit 60 can be provided outside the active matrix substrate 100 (e.g., in the signal processing circuit 8), or in the sensor row driver 5.

In the present embodiment as well, the compensation circuit 60 adjusts an amplitude of the readout signal according to a degree of divergence between a value (gray scale data) obtained by A/D conversion of an output signal voltage Vout_D2 from the reference sensor and the standard offset value. In other words, as explained with reference to FIG. 7 in the description of Embodiment 1, the RWS generation circuit 62 of the compensation circuit 60 increases the potential of the high level V_{RWS.H} of the readout signal, which is V_{DDD} before correction (see FIG. 4), by α. Thus, the RWS generation circuit 62 increases the amplitude (V_{RWS.H}−V_{RWS.L}) of the readout signal by α.

Thus, as explained in the description of Embodiment 1 with reference to FIG. 8, the potential of the high level V_{RWS.H} of the readout signal is set to (V_{DDD}+α), and thereby the potential of V_{INT} increases by a voltage ΔV corresponding to the offset α.

As described above, by setting the potential of the high level V_{RWS.H} of the readout signal to (V_{DDD}+α) according to the degree of divergence between the gray scale data of the output signal voltage Vout_D2 and the standard offset value, a signal with an offset due to a dark current or the like being eliminated can be obtained as an output signal voltage Vout_D1.

According to the present embodiment as well, subtraction of an output of the reference sensor from an output of the photodetecting sensor as in the conventional configuration is not needed. Therefore, a problem that the dynamic range of the sensor output is narrowed does not arise. This makes it possible to realize a display device that is capable of detecting an intensity of external light with high precision without being influenced by ambient temperature, and that is provided with an optical sensor having a wide dynamic range.

It should be noted that, here, the amplitude of the readout signal is increased by a by changing the potential of the high level V_{RWS.H} of the readout signal from V_{DDD} to (V_{DDD}+α). However, as shown in FIG. 9, which is referred to in conjunction with Embodiment 1, by changing the potential of the low level V_{RWS.L} of the readout signal from V_{SSR} to (V_{SSR}−α), the amplitude of the readout signal can be increased by α, and therefore, the same effect can be achieved.

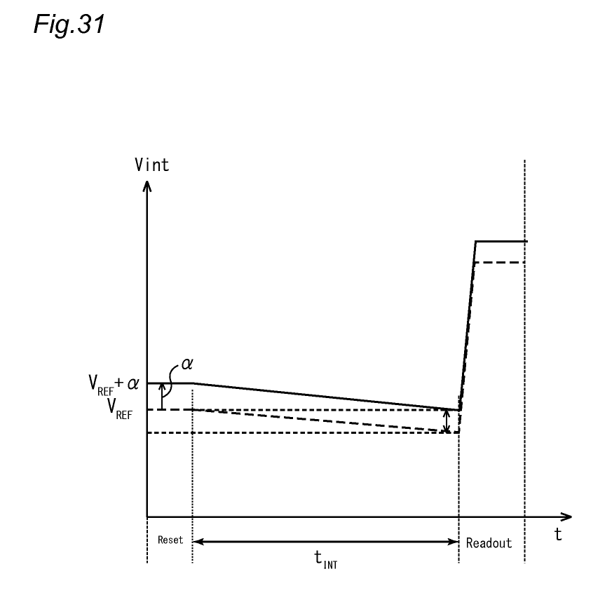

Alternatively, as is the case with Embodiment 4, the configuration may be such that the reset level potential V_{REF}, in place of the amplitude of the readout signal, may be adjusted according to a degree of divergence between the gray scale data of the output signal voltage Vout_D2 and the standard offset value. In this case, the compensation circuit 90 shown in FIG. 28, which is referred to in conjunction with Embodiment 4, is provided in place of the compensation circuit 60. The reset level potential V_{REF} is increased by a by the compensation circuit 90 thus provided, whereby the potential of V_{INT} upon reset increases by a voltage corresponding to the offset α, as shown in FIG. 31. This causes a value with the offset being cancelled to be output upon readout. It should be noted that in FIG. 31, the solid line indicates potential variation of V_{INT} before correction of the reset level potential V_{REF}, and the broken line indicates the potential variation of V_{INT} after correction.

### Exemplary Modification of Embodiments 1 to 5

So far Embodiments 1 to 5 of the present invention have been explained, but the present invention is not limited to the embodiments described above, and can be modified variously within the scope of the present invention.

As Embodiments 1 to 5, exemplary configurations in which the lines VDD and OUT connected to the optical sensor double as the source lines COL are shown. These configurations have an advantage of a high pixel aperture ratio. With a configuration in which the lines VDD and OUT for the optical sensors are provided separately from the source lines COL, however, the same effect as that of the above-described embodiments can be achieved.

### INDUSTRIAL APPLICABILITY

The present invention is industrially applicable as a display device having an optical sensor function.

1. A display device having optical sensors in a pixel region of an active matrix substrate,
wherein the optical sensors include a photodetecting sensor which outputs a sensor signal according to an amount of received light, and a reference sensor which has a configuration obtained by adding a light shielding film to the photodetecting sensor and outputs a sensor signal according to an offset component,
the display device comprising:
an offset comparison circuit that determines a degree of divergence between the sensor signal output from the reference sensor and a standard offset value; and
a driving signal generation circuit that adjusts a potential of a driving signal for the optical sensors according to the degree of divergence determined by the offset comparison circuit.

2. The display device according to claim 1,
wherein each of the optical sensors includes:
a light receiving element;
a capacitor that charges/discharges an output electric current from the light receiving element;
a switching element that is connected between one end of the light receiving element and one end of the capacitor;
a reset signal line that is connected to the other end of the light receiving element and supplies a reset signal; and
a readout signal line that is connected to the other end of the capacitor and supplies a readout signal,
wherein the driving signal generation circuit adjusts at least one of potentials of a high level and a low level of the readout signal.

3. The display device according to claim 1,
wherein each of the optical sensors includes:
a light receiving element;
a variable capacitor that charges/discharges an output electric current from the light receiving element;
a switching element that is connected between one end of the light receiving element and one end of the variable capacitor;
a reset signal line that is connected to the other end of the light receiving element and supplies a reset signal; and
a readout signal line that is connected to the other end of the variable capacitor and supplies a readout signal,
wherein the driving signal generation circuit adjusts a potential of a low level of the readout signal.

4. The display device according to claim 1,
wherein each of the optical sensors includes:
a light receiving element;
a capacitor that charges/discharges an output electric current from the light receiving element;
a switching circuit that is connected between one end of the light receiving element and one end of the capacitor;
a reset signal line that is connected to the other end of the light receiving element and supplies a reset signal; and
a readout signal line that supplies a readout signal to the optical sensor,
wherein the driving signal generation circuit adjusts a potential of a high level of the reset signal.

5. The display device according to claim 4,
wherein the switching circuit includes one transistor, and
the readout signal line is connected to the other end of the capacitor.

6. The display device according to claim 4,
wherein the switching circuit includes a first transistor and a second transistor,
a control electrode of the first transistor is connected between one end of the light receiving element and one end of the capacitor,
one of two electrodes other than the control electrode in the first transistor is connected to a line that supplies a constant voltage,
the other one of the two electrodes other than the control electrode in the first transistor is connected to one of two electrodes other than a control electrode in the second transistor,
the other one of the two electrodes other than the control electrode in the second transistor is connected to an output line for outputting the sensor signal,
the readout signal line is connected to the control electrode of the second transistor, and
the other end of the capacitor is connected to a line that supplies a constant voltage.

7. The display device according to claim 4,
wherein the switching circuit includes a first transistor, a second transistor, and a third transistor,
a control electrode of the first transistor is connected between one end of the light receiving element and one end of the capacitor,
one of two electrodes other than the control electrode in the first transistor is connected to a line that supplies a constant voltage,
the other one of the two electrodes other than the control electrode in the first transistor is connected to one of two electrodes other than a control electrode in the second transistor,
the other one of the two electrodes other than the control electrode in the second transistor is connected to an output line for outputting the sensor signal,
the other end of the capacitor is connected to a line that supplies a constant voltage,
the readout signal line is connected to the control electrode of the second transistor,
the reset signal line is connected to a control electrode of the third transistor,
one of two electrodes other than the control electrode in the third transistor is connected to one end of the light receiving element,
the other one of the two electrodes other than the control electrode in the third transistor is connected to a line that supplies a reference voltage, and
the driving signal generation circuit adjusts a potential of the reference voltage for the third transistor.

8. The display device according to claim 4,
wherein the switching circuit includes a first transistor and a second transistor,
a control electrode of the first transistor is connected between one end of the light receiving element and one end of the capacitor,
one of two electrodes other than the control electrode in the first transistor is connected to a line that supplies a constant voltage,
the other one of the two electrodes other than the control electrode in the first transistor is connected to an output line for outputting the sensor signal,
the other end of the capacitor is connected to the readout signal line,
the reset signal line is connected to a control electrode of the second transistor,
one of two electrodes other than the control electrode in the second transistor is connected to one end of the light receiving element,
the other one of the two electrodes other than the control electrode in the second transistor is connected to a line that supplies a reference voltage, and
the driving signal generation circuit adjusts at least one of potentials of a high level and a low level of the readout signal.

9. The display device according to claim 4,
wherein the switching circuit includes a first transistor and a second transistor,
a control electrode of the first transistor is connected between one end of the light receiving element and one end of the capacitor,
one of two electrodes other than the control electrode in the first transistor is connected to a line that supplies a constant voltage,
the other one of the two electrodes other than the control electrode in the first transistor is connected to an output line for outputting the sensor signal,
the other end of the capacitor is connected to the readout signal line,
the reset signal line is connected to a control electrode of the second transistor,
one of two electrodes other than the control electrode in the second transistor is connected to one end of the light receiving element,
the other one of the two electrodes other than the control electrode in the second transistor is connected to a line that supplies a reference voltage, and
the driving signal generation circuit adjusts a potential of the reference voltage.

10. The display device according to claim 1 further comprising:
a counter substrate opposed to the active matrix substrate; and
liquid crystal interposed between the active matrix substrate and the counter substrate.
